(19) United States
(12) Patent Application Publication
(10) Pub. No.: US 2005/0265720 A1
(43) Pub. Date: Dec. 1, 2005

(54) Wavelength division multiplexing add/drop system employing optical switches and interleavers

(76) Inventors: Peiching Ling, San Jose, CA (US); Jianjun Zhang, Cupertino, CA (US); Wayne W. Lui, Fremont, CA (US); Jinliang Chen, Saratoga, CA (US); Ming Xu, San Jose, CA (US)

Correspondence Address: PERKINS COIE LLP;PATENT-SEA, P.O. BOX 1247, SEATTLE, WA, 98111-1247, US

(21) Appl. No.: 10/857,092

(22) Filed: May 28, 2004

(51) Int. Cl. H04J 14/02

(52) U.S. Cl. 398/83

(57) ABSTRACT

An optical add/drop multiplexer (OADM) having reduced crosstalk is disclosed. The OADM uses an optical interleaver to separate channels of a wavelength division multiplexed signal into a plurality of branches. The branches then separately act on the widely spaced channels to add or drop channels. After the add/drop function is completed, the channels on the branches are recombined.

### BACKGROUND OF THE INVENTION

1. Field of the Invention

This invention relates generally to design and manufacturing of multiple wavelength add/drop systems used in optical communications. Each system is comprised of wavelength selective optical switches and optical wavelength interleavers.

2. Description of the Related Art

Optical wavelength division multiplexing (WDM) is an important method used in modern optical fiber communication systems to drastically increase data transmission rate. In WDM systems, communication is by means of transmitting and receiving optical pulses consisting of signals with different wavelengths (wavelength channels). Each wavelength channel carries its own data information transmitted over optical fibers. The main advantage with WDM technology is, therefore, that a single optical fiber can be used to transmit a number of distinguishable optical signals simultaneously. The result is a significant increase of effective bandwidth of the optical fiber and data transmission rate of the communication system.

In WDM networks of the past, adding, dropping or cross-connection of individual wavelengths involved conversion of optical signals into electronic signals first. After appropriate manipulations of the electronic signals, the electronic signals are converted back to optical signals before being delivered via optical fibers. These conversions became the bottleneck of the WDM networks. Development of all-optical switches for applications ranging from add-drop functionality to large-scale cross-connects is key to adding intelligence to the optical layer of, and thereby enhancing, the optical networking systems. However, with current technical limitations, all fiber network systems implemented with optical switches are still expensive.

The current state of the art in optical switching and signal transmission systems, moreover, are limited to optical switching of an entire spectral range without wavelength differentiation or selection. As a result, an optical switch operation often requires a wavelength de-multiplexer and a multiplexer to achieve the transfer of optical signals of different wavelengths to different ports. This is interpreted into more complicated system configurations, higher manufacture and maintenance costs, and lower system reliability.

Designs of all optical add/drop multiplexers (OADM) were proposed (see Okamoto, “Recent progress of integrated optics planar lightwave circuits,” Optical and Quantum Electronics, Vol. 31, pp. 107-129, 1999). In conventional designs, optical signals undergo three basic steps within an OADM. First, all wavelength channels are demultiplexed. Optical signals are then dropped from, or added to, one or few chosen wavelength channels. Finally all channels are multiplexed back together. In this process, even if only signals from one channel are modified, signals in all channels are disturbed. After several passes through OADM's, signals in all channels are necessarily degraded. This presents a cascade problem.

In U.S. patent application Ser. No. 10/188,955, an OADM utilizing optical switches based on a novel grating-assisted coupler had been suggested. In this structure, optical switches are chained one after another. The number of optical switches used is directly proportional to the number of channels of the OADM. As propagation loss of the optical signals is also proportional to the number of optical switches and the total optical path length, power loss can be significant if the OADM channel number is large.

In this invention, a modified and improved architecture is suggested to rectify this disadvantage.

### BRIEF DESCRIPTIONS OF THE DRAWINGS

The present invention can be better understood with reference to the following drawings. The components within the drawings are not necessarily to scale relative to each other, emphasis instead being placed upon clearly illustrating the principles of the present invention.

FIG. 1 is a graph illustrating the source of channel crosstalk in a conventional OADM when it is in the “off” state.

FIGS. 2 and 4 are schematic diagrams showing the two different modes of operations of a prior art 1:2 optical wavelength interleaver.

FIGS. 3A to 3C describe the input and output characteristics of the prior art 1:2 optical wavelength interleaver shown in FIGS. 2 and 4.

FIGS. 5A˜5B are schematic diagrams showing the two different modes of operations of a prior art 1:4 optical wavelength interleaver.

FIGS. 6A˜6E describe the input and output characteristics of the prior art 1:4 optical wavelength interleaver shown in FIGS. 5A and 5B.

FIGS. 7A˜7B are schematic diagrams showing, respectively, a two-to-one and a four-to-one optical waveguide combiner.

FIG. 8 is a schematic diagram showing the function of a prior art optical circulator.

FIG. 9 is a schematic diagram showing the function of a prior art optical isolator.

FIG. 10A is a schematic diagram showing the function of a wavelength selective optical “drop” switch when it is in the “off” state; FIG. 10B is a graph explaining the drastic reduction of channel crosstalk in this case.

FIGS. 11A˜11B are schematic diagrams showing functions of, respectively, a wavelength selective (λ₃) optical “drop” switch and a similar “add” switch. The bold outline of the elements indicates that the switches are in the “on” state.

FIGS. 12A˜12C are schematic diagrams showing the structure and operations of a 4-channel OADM which is based on the 1:2 optical wavelength interleavers as shown in FIGS. 2 and 4 and the wavelength selective optical “drop” and “add” switches as shown in FIGS. 11A and 11B.

FIG. 13 is a schematic diagram showing the structure of a 4-channel OADM which is based on the 1:2 optical wavelength interleaver as shown in FIG. 2, the two-to-one optical waveguide combiner as shown in FIG. 7A, and the wavelength selective optical “drop” and “add” switches as shown in FIGS. 11A˜11B.

FIG. 14A is a plot illustrating the channel crosstalk problem in the case that the bandwidth of the wavelength selective optical switches is too wide compared to the channel bandwidth.

FIG. 14B shows that the channel crosstalk problem can be avoided if the neighboring channels are farther apart.

FIGS. 15A˜15C are schematic diagrams showing the structure and operations of an 8-channel OADM which is based on the 1:4 optical wavelength interleavers as shown in FIGS. 5A and 5B and the wavelength selective optical “add” and “drop” switches as shown in FIGS. 11A˜11B.

FIG. 16 is a schematic diagram showing the structure of an 8-channel OADM which is based on the 1:4 optical wavelength interleavers as shown in FIG. 5A, the four-to-one optical waveguide combiner as shown in FIG. 7B, and the wavelength selective optical “add” and “drop” switches as shown in FIGS. 11A˜11B.

FIG. 17 is a schematic diagram showing functions of a wavelength selective (λ₃) optical “add/drop” switch. The bold outline of the element indicates that the switch is in the “on” state.

FIGS. 18A˜18B are schematic diagrams showing the structure and operations of a 4-channel OADM which is based on the 1:2 optical wavelength interleavers as shown in FIGS. 2 and 4 and the wavelength selective optical “add/drop” switch as shown in FIG. 17.

FIG. 19 is a schematic diagram showing the structure of a 4-channel OADM which is based on the 1:2 optical wavelength interleaver as shown in FIG. 2, the two-to-one optical waveguide combiner as shown in FIG. 7A, and the wavelength selective optical “add/drop” switch as shown in FIG. 17.

FIGS. 20A˜20B are schematic diagrams showing the structure and operations of an 8-channel OADM which is based on the 1:4 optical wavelength interleavers as shown in FIGS. 5A and 5B and the wavelength selective optical “add/drop” switch as shown in FIG. 17.

FIG. 21 is a schematic diagram showing the structure of an 8-channel OADM which is based on the 1:4 optical wavelength interleaver as shown in FIG. 5A, the four-to-one optical waveguide combiner as shown in FIG. 7B, and the wavelength selective optical “add/drop” switch as shown in FIG. 17.

FIG. 22 is a schematic diagram showing functions of a wavelength selective (λₖ) reflective optical switch. The bold outline of the element indicates that the switch is in the “on” state.

FIG. 23 is a structural schematic showing a grating-based wavelength selective reflective optical switch when it is in the “on” state.

FIGS. 24A˜24B are schematic diagrams showing the structure and operations of a 4-channel optical “drop” multiplexer which is based on the 1:2 optical wavelength interleavers as shown in FIGS. 2 and 4, the optical circulator as shown in FIG. 8, and wavelength selective reflective optical switches as shown in FIG. 22.

FIG. 25 is a schematic diagram showing the structure of a 4-channel optical “drop” multiplexer which is based on the 1:2 optical wavelength interleaver as shown in FIG. 2, the two-to-one optical waveguide combiner as shown in FIG. 7A, the optical circulator as shown in FIG. 8, and wavelength selective reflective optical switches as shown in FIG. 22.

FIGS. 26A˜26B are schematic diagrams showing the structure and operations of an 8-channel optical “drop” multiplexer which is based on the 1:4 optical wavelength interleavers as shown in FIGS. 5A˜5B, the optical circulator as shown in FIG. 8, and wavelength selective reflective optical switches as shown in FIG. 22.

FIG. 27 is a schematic diagram showing the structure of an 8-channel optical “drop” multiplexer which is based on the 1:4 optical wavelength interleaver as shown in FIG. 5A, the four-to-one optical waveguide combiner as shown in FIG. 7B, the optical circulator as shown in FIG. 8, and wavelength selective reflective optical switches as shown in FIG. 22.

FIG. 28A is a schematic diagram showing functions of a multi-wavelength optical blocking device, which is based on wavelength selective reflective optical switches as shown in FIG. 22 and the optical isolator as shown in FIG. 9, when it is in the “off” state; the bold outline of the wavelength selective (λ₂) reflective optical switch in FIG. 28B indicates that the switch is in the “on” state.

FIGS. 29A˜29B are schematic diagrams showing the structure and operations of a multi-wavelength optical blocking device which is based on the 1:2 optical wavelength interleavers as shown in FIGS. 2 and 4, the optical isolator as shown in FIG. 9, and wavelength selective reflective optical switches as shown in FIG. 22.

FIG. 30 is a schematic diagram showing the structure of a multi-wavelength optical blocking device which is based on the 1:2 optical wavelength interleaver as shown in FIG. 2, the two-to-one optical waveguide combiner as shown in FIG. 7A, the optical isolator as shown in FIG. 9, and wavelength selective reflective optical switches as shown in FIG. 22.

FIGS. 31A˜31B are schematic diagrams showing the structure and operations of a multi-wavelength optical blocking device which is based on the 1:4 optical wavelength interleavers as shown in FIGS. 5A˜5B, the optical isolator as shown in FIG. 9, and wavelength selective reflective optical switches as shown in FIG. 22.

FIG. 32 is a schematic diagram showing the structure of a multi-wavelength optical blocking device which is based on the 1:4 optical wavelength interleaver as shown in FIG. 5A, the four-to-one optical waveguide combiner as shown in FIG. 7B, the optical isolator as shown in FIG. 9, and wavelength selective reflective optical switches as shown in FIG. 22.

### DETAILED DESCRIPTION OF THE PREFERRED EMBODIMENT

Some Prior Art Optical Devices

The present invention builds on previous work of the assignee of the present invention. For example, in co-pending U.S. patent application Ser. No. 10/188,955 filed Jul. 3, 2002 and herein incorporated by reference, an optical switching and routing system is shown that uses grating based wavelength selective switches. Similarly, in co-pending U.S. patent application Ser. No. 10/190,018 filed Jul. 5, 2002 and herein incorporated by reference, a Bragg grating switch is shown. These devices are used extensively throughout the present invention. However, for the sake of clarity, the details of those switches is described in detail. From a functional standpoint, the switches are operative to add or drop selected wavelengths from a multiplexed signal carried by an optical waveguide or fiber. The switching of the switches can be accomplished either thermally, electronically, or mechanically.

Other types of “add/drop” switches are also suitable for use in the present invention. For example, one-ring resonators, such as those described in U.S. Pat. No. 6,411,752 are one alternative. The wavelength of the optical switch can be altered, for instance, via a heater placed above or in close proximity to the micro-ring. In the case that the micro-ring is made of semiconductor material, wavelength of the optical switch can be adjusted electrically by controlling the current injection level. Or if the micro-ring is moveable, wavelength of the optical switch can be adjusted mechanically.

Similar optical “add/drop” switches based on multi-ring resonators, such as those suggested by Hryniewicz, et al in “Higher Order Filter Response in Coupled Microring Resonators,” IEEE Photonics Technology Letters, Vol. 12, No. 3, pp. 320-322, March 2000, are another alternative.

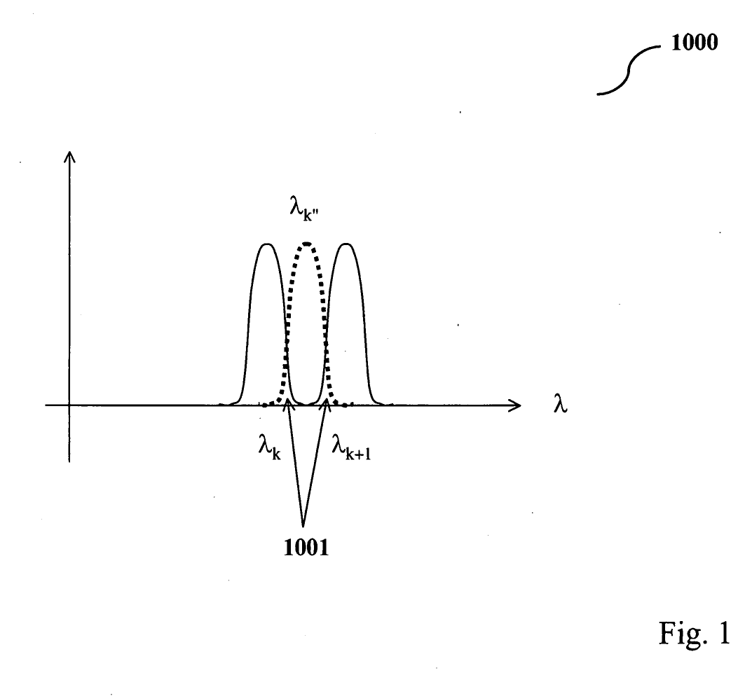

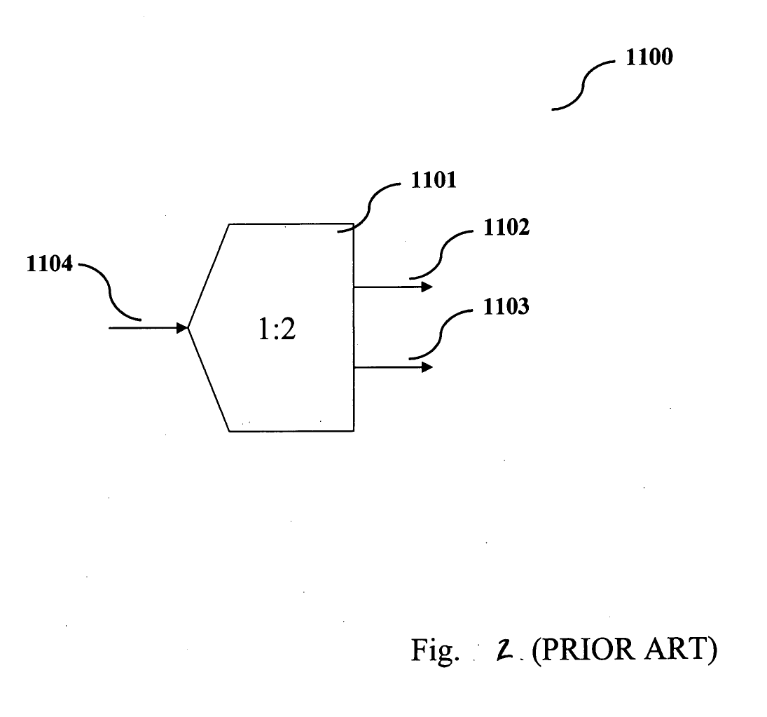

In a conventional multi-wavelength (λₖ) optical switch when the switch is in the “off” state, there is the problem of channel cross-talk. The wavelength selective (λₖ) optical switch is said to be in the “off” state when the switch is tuned to a wavelength other than λₖ, for example, at λ_{k″} (that is, λ_{k″}≠λₖ). In order not to interfere with other channels, the wavelength λ_{k″} cannot be the same as any of the channel wavelengths. This means that λ_{k″} is necessarily in between channel wavelengths as shown in FIG. 1. If channel spacing is small compared with the bandwidth of the optical switch, this may result in (a) channel crosstalk and/or (b) unnecessary power loss among neighboring channels.

An interleaver is a periodic optical filter that combines or separates a comb of WDM signals. The operations and functions of interleavers are well-known (see, for example, S. Cao et al, “Interleaver Technology: Comparisons and Applications Requirements,” IEEE Journal of Lightwave Technology, Vol. 22, No. 1, pp. 281-289, January 2004).

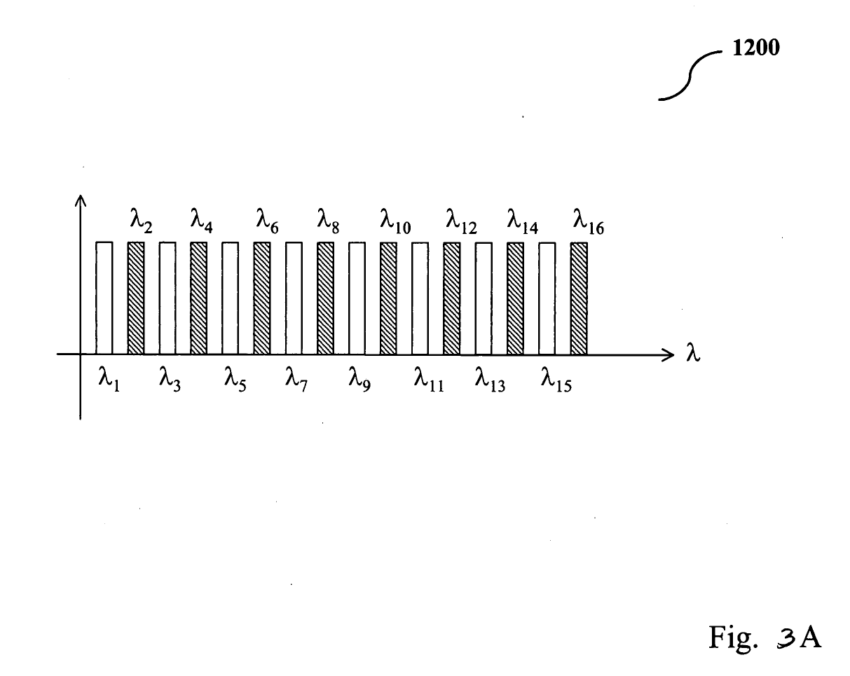

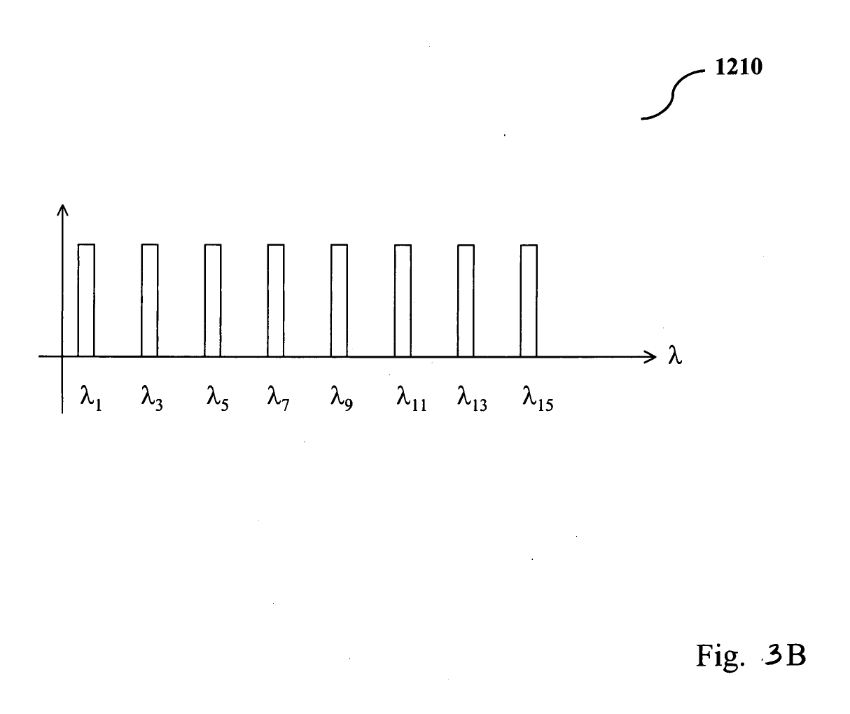

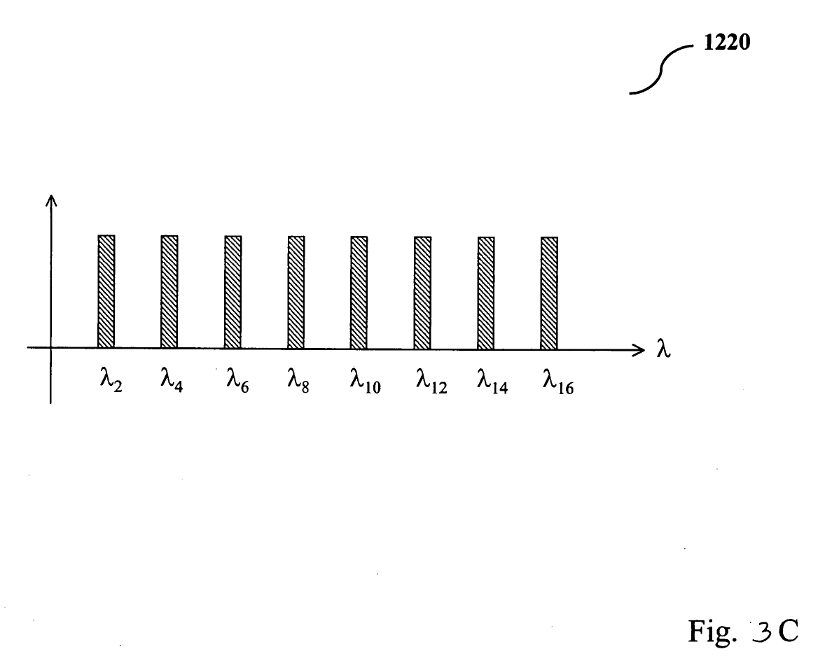

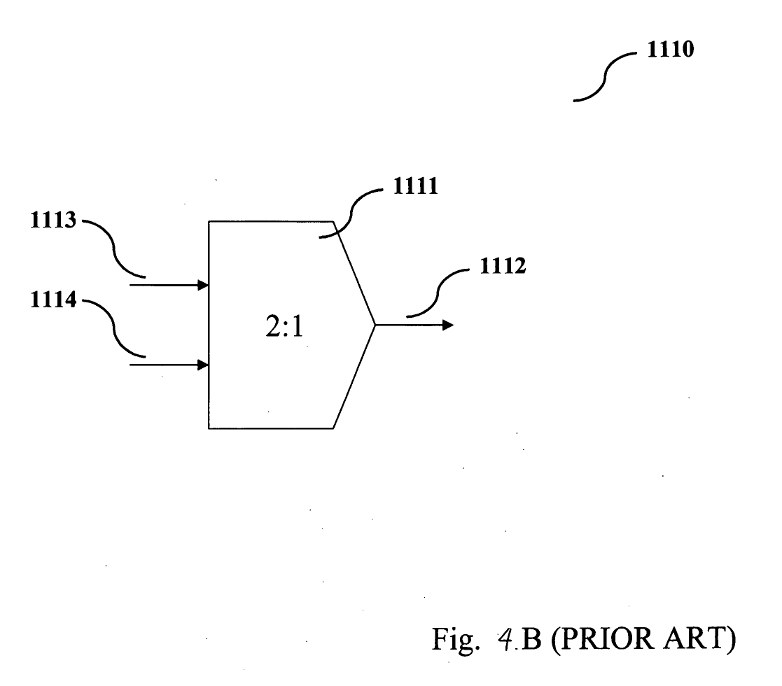

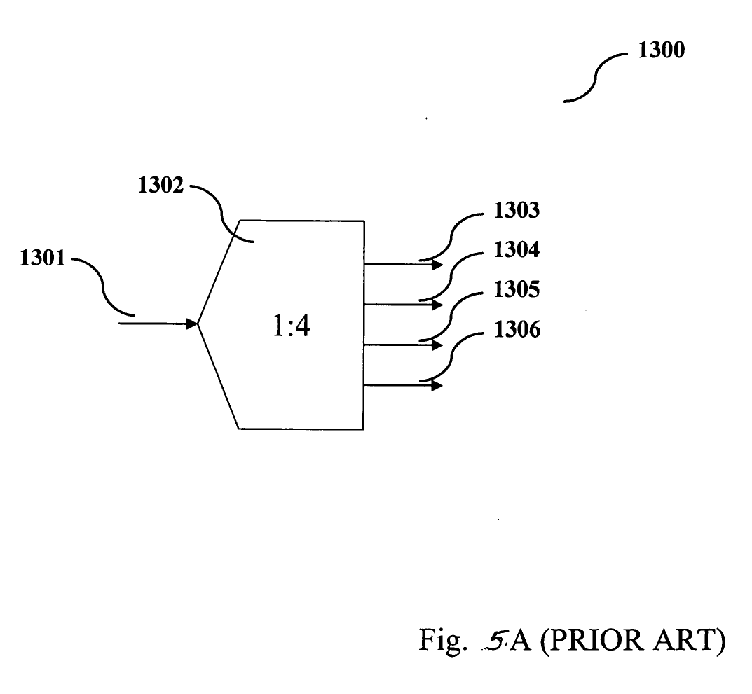

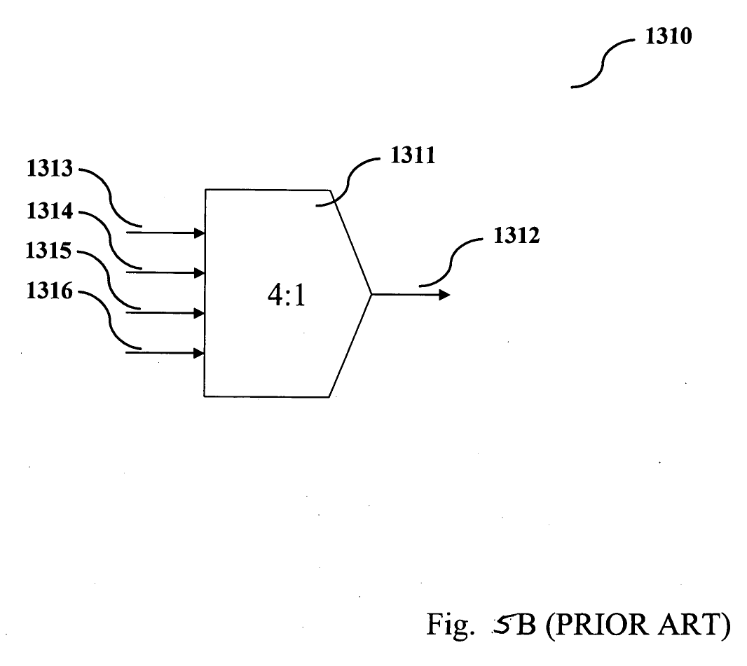

FIG. 2 illustrates a prior art 1:2 optical wavelength interleaver 1101 with its input port 1104 and output ports 1102 and 1103. In this configuration, it separates the set of WDM signals as shown in FIG. 3A into two separate sets as shown in FIGS. 3B and 3C, respectively. Similarly, FIG. 4 illustrates a prior art 2:1 interleaver 1111 with its input ports 1113 and 1114 and output port 1112. It combines the two sets of WDM signals as shown in FIGS. 3B and 3C into one set as shown in FIG. 3A. In other words, the input/output characteristics of an optical wavelength interleaver are reciprocated.

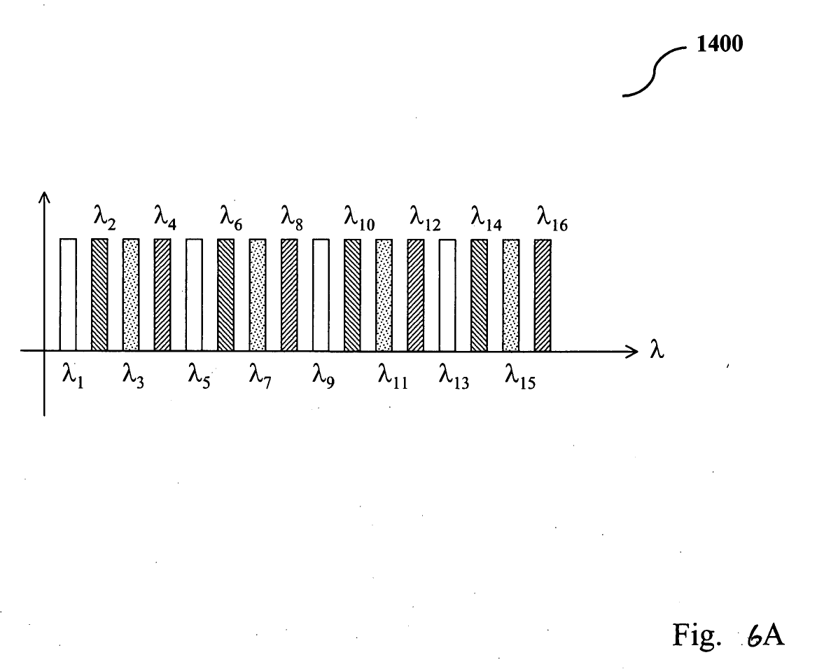

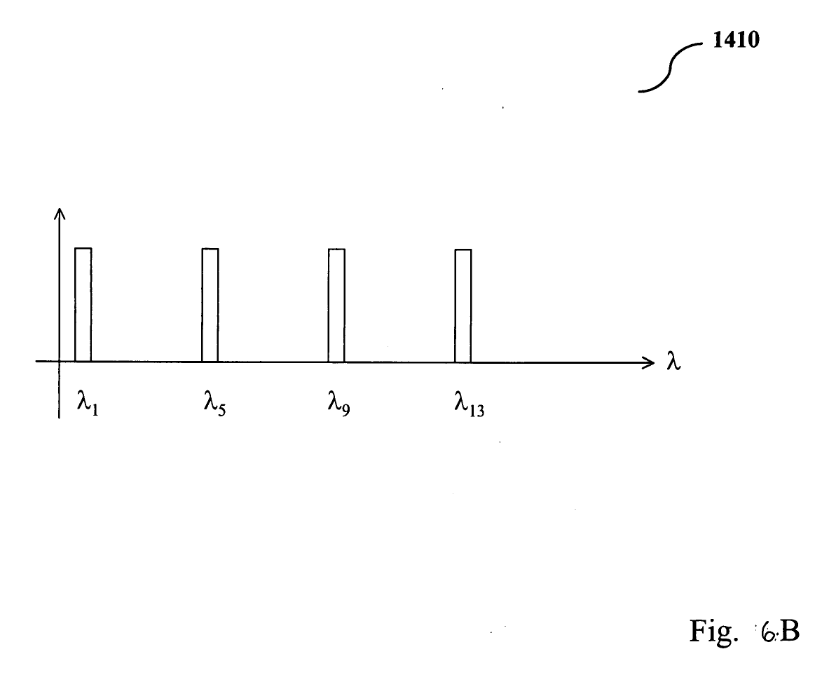

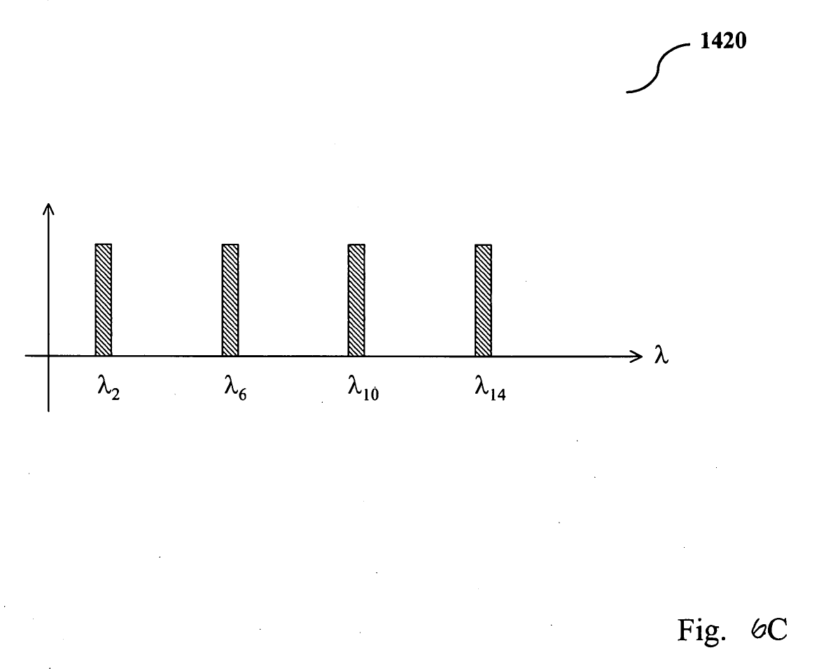

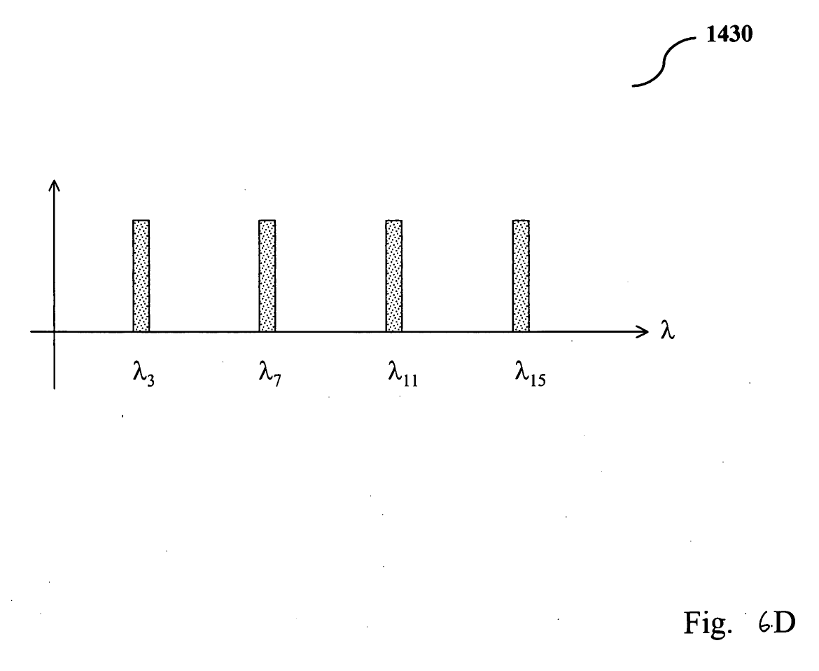

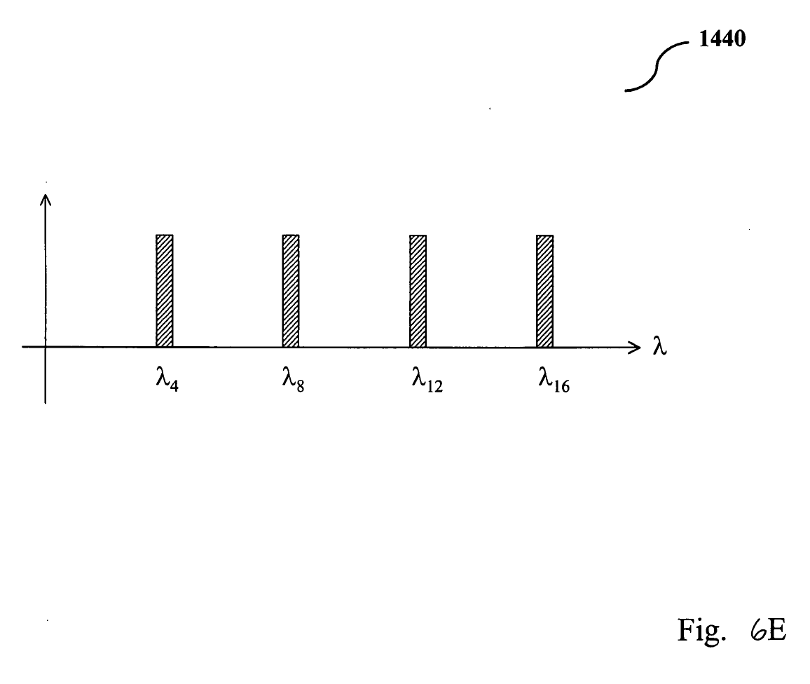

The schematics of the two different modes of a prior art 1:4 optical wavelength interleaver are shown in FIGS. 5A˜5B. As in the case of the 1:2 optical wavelength interleaver, if the WDM signals at the input port 1301 of the 1:4 optical wavelength interleaver 1302 are as shown in FIG. 6A, the interleaver separates the input signals into four streams such that the output WDM signals at ports 1303, 1304, 1305 and 1306 are as shown in FIGS. 6B, 6C, 6D and 6E, respectively.

Conversely, in the case of the 4:1 optical wavelength interleaver 1311 as shown in FIG. 5B, if the WDM signals at the input ports 1313, 1314, 1315 and 1316 are, respectively, as shown in FIGS. 6B, 6C, 6D and 6E, then the interleaver combines the input signals into one single stream such that the output WDM signals at port 1312 is as shown in FIG. 6A. Thus, similar to the case of the 1:2 optical wavelength interleavers, the input/output characteristics of the 1:4 optical wavelength interleavers are also reciprocated.

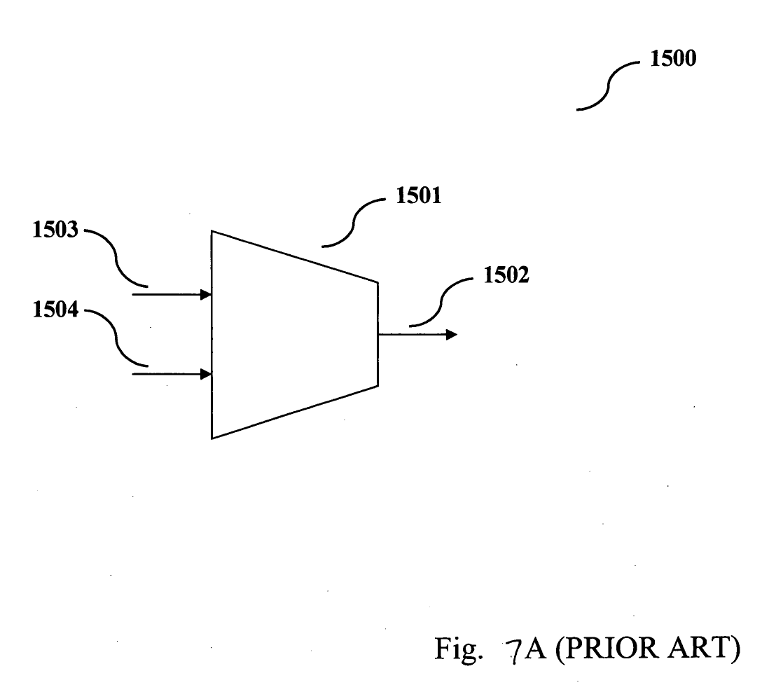

Another type of optical device is an optical waveguide combiner, which is shown in FIGS. 7A˜7B. The input/output characteristics of the 2:1 optical waveguide combiner 1501 (FIG. 7A) is such that if the input 1503 and 1504 are, respectively, as shown in FIGS. 3B and 3C, then the output 1502 is as shown in FIG. 3A. In this sense, the optical waveguide combiner functions similar to a 2:1 optical wavelength interleaver.

Likewise, the input/output characteristics of a 4:1 optical waveguide combiner 1511 (FIG. 7B) is not too different from a 4:1 optical wavelength interleaver (FIG. 5B). If the input 1513, 1514, 1515 and 1516 are as shown in FIGS. 6B, 6C, 6D and 6E, respectively, than the output 1512 is as shown in FIG. 6A.

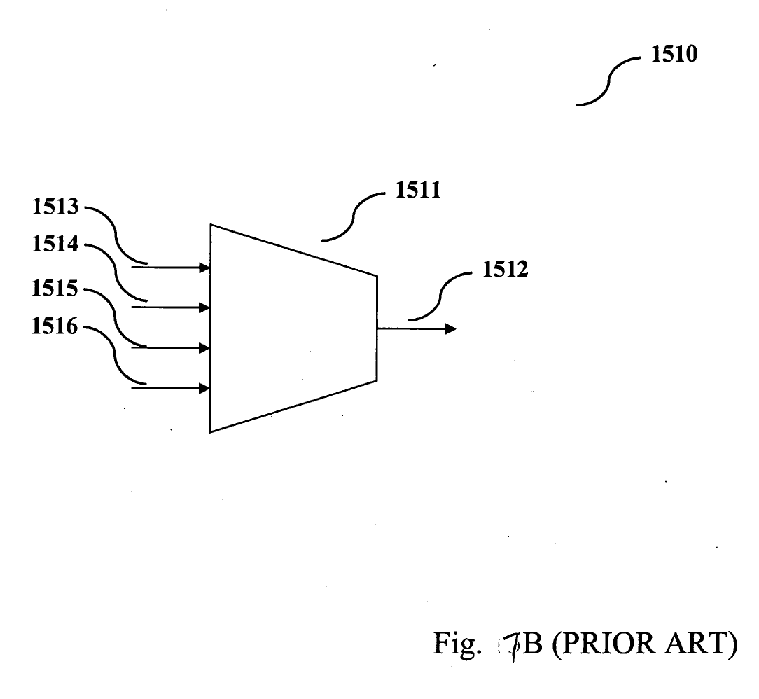

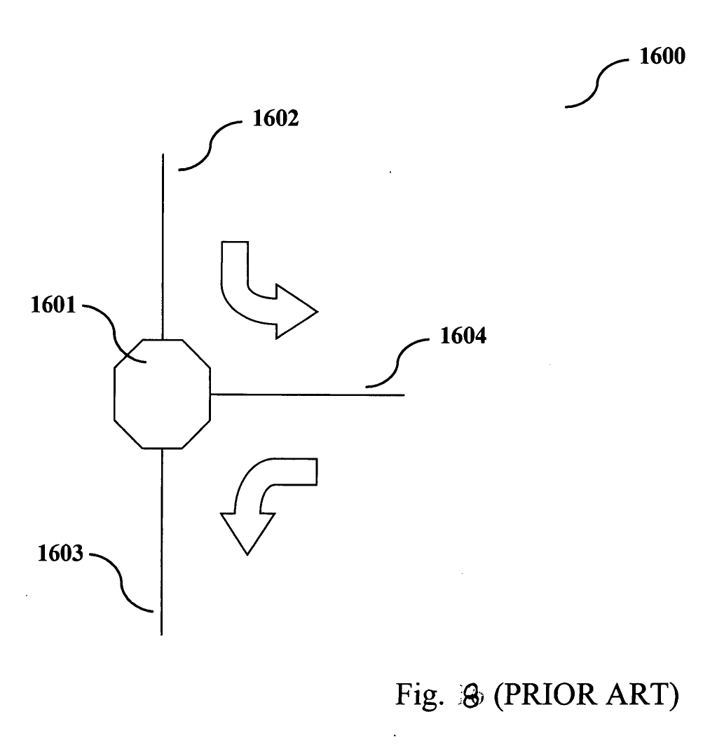

An optical circulator 1601 is shown in FIG. 8. Input signals at port 1602 are directed to port 1604, whereas input signals at port 1604 are directed to port 1603.

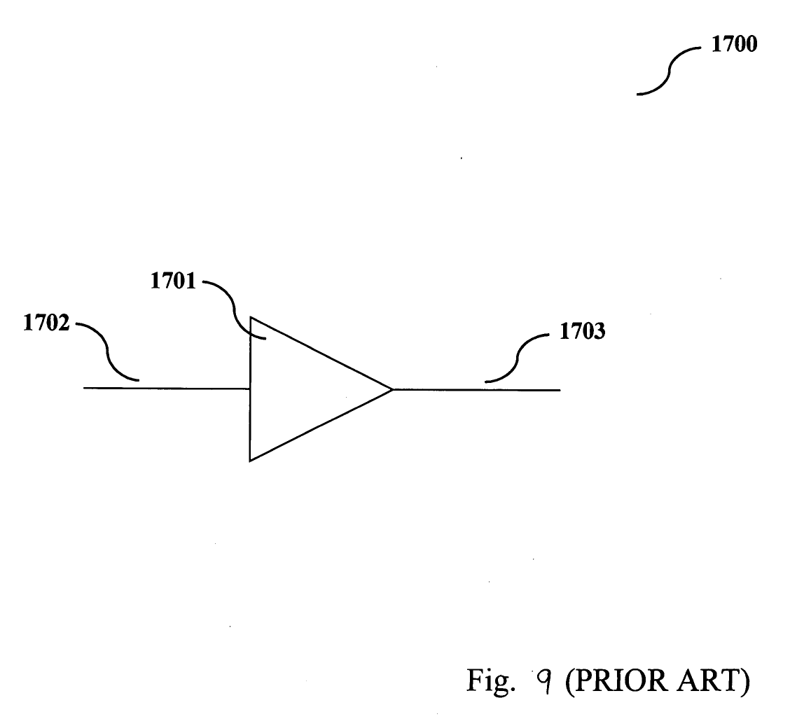

An optical isolator 1701 is shown in FIG. 9. The device appears transparent to forward-propagating optical signals traversing from port 1702 to port 1703. The device appears opaque for optical signals propagating in the opposite direction, however. Optical signals at port 1703 are blocked from reaching port 1702.

As will be seen below, the above prior art devices are used to implement an OADM device with significantly reduced crosstalk.

OADM Architecture of the Present Invention

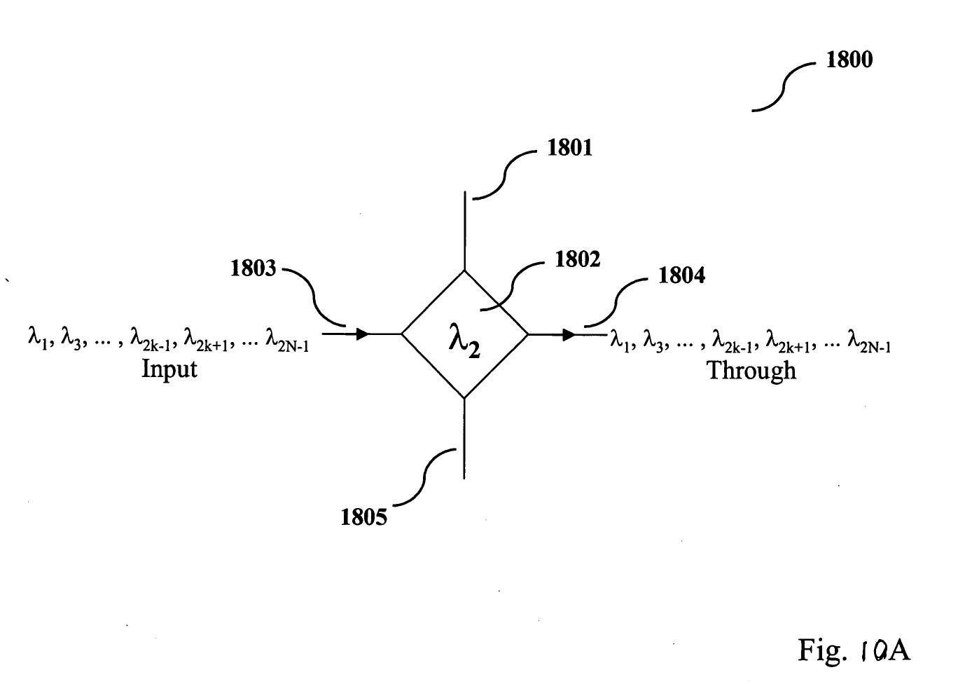

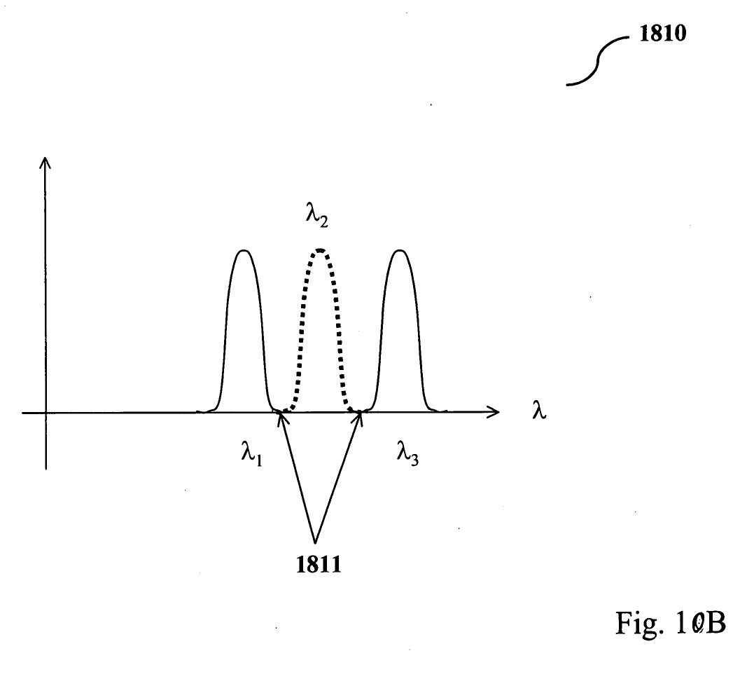

A wavelength selective (λ₂) optical “drop” switch of the present invention is shown in FIG. 10A, which is in the “off” state. Since the switch wavelength is different from wavelengths of all input signals, the switch is transparent to all input signals. Turning to FIG. 10B, it can be seen that there is a substantial reduction of channel crosstalk.

Notice that in the optical drop switch 1802 of FIG. 10A, the spacing between adjacent channels is designed to be twice as much compared to the prior art. As a result, while the drop switch 1802 is in the “off” state, it can occupy the space of a channel that is not being used. This is illustrated in FIG. 10B. Channel crosstalk and/or power loss between neighboring channels are thereby substantially reduced.

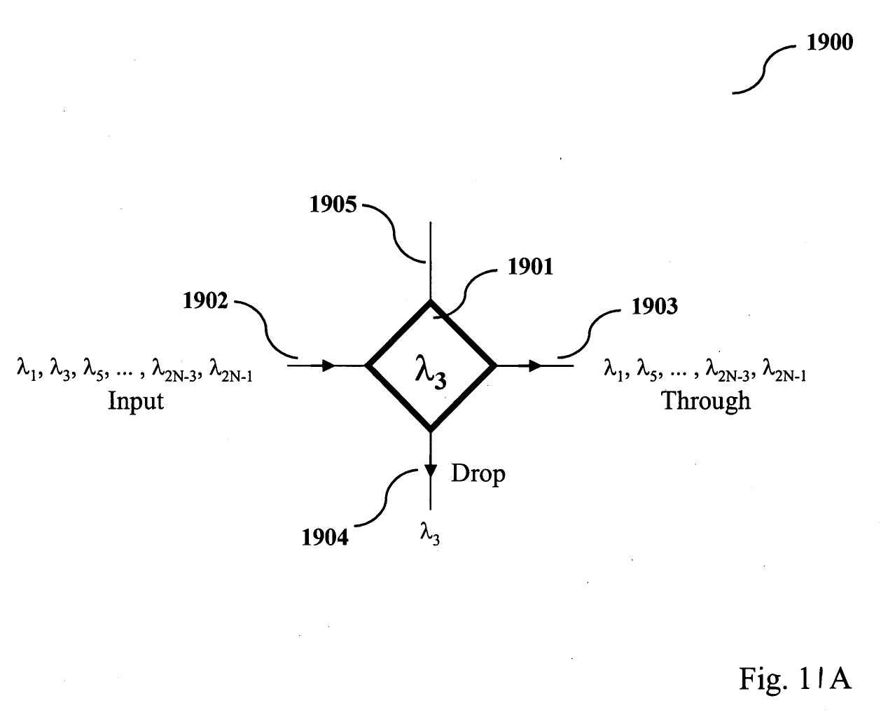

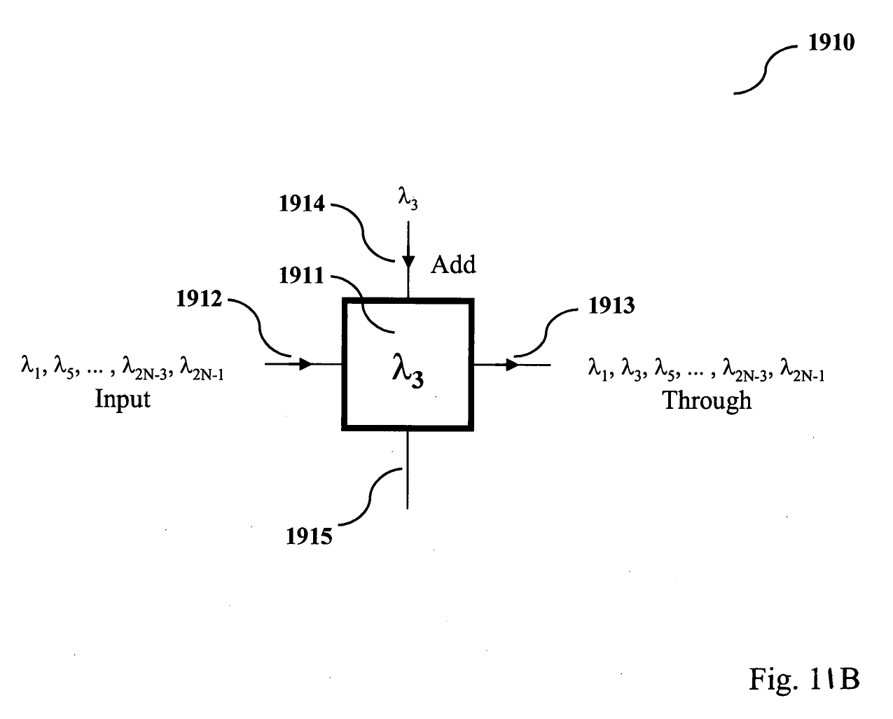

A wavelength selective (λ₃) optical “drop” switch and a similar “add” switch is shown in FIGS. 11A˜11B, respectively. The bold outline of the elements indicates that they are in the “on” state (contrast to FIG. 10A).

When the wavelength selective (λ₃) optical “drop” switch in FIG. 11A is “on”, signals with wavelength λ₃ from input port 1902 are directed to “drop” port 1904. The switch is transparent to all other input wavelengths otherwise.

Similarly, when the wavelength selective (λ₃) optical “add” switch in FIG. 11B is “on”, signals with wavelength λ₃ coming from the “add” port 1914 are directed to output port 1913. The switch is transparent to all other input wavelengths otherwise.

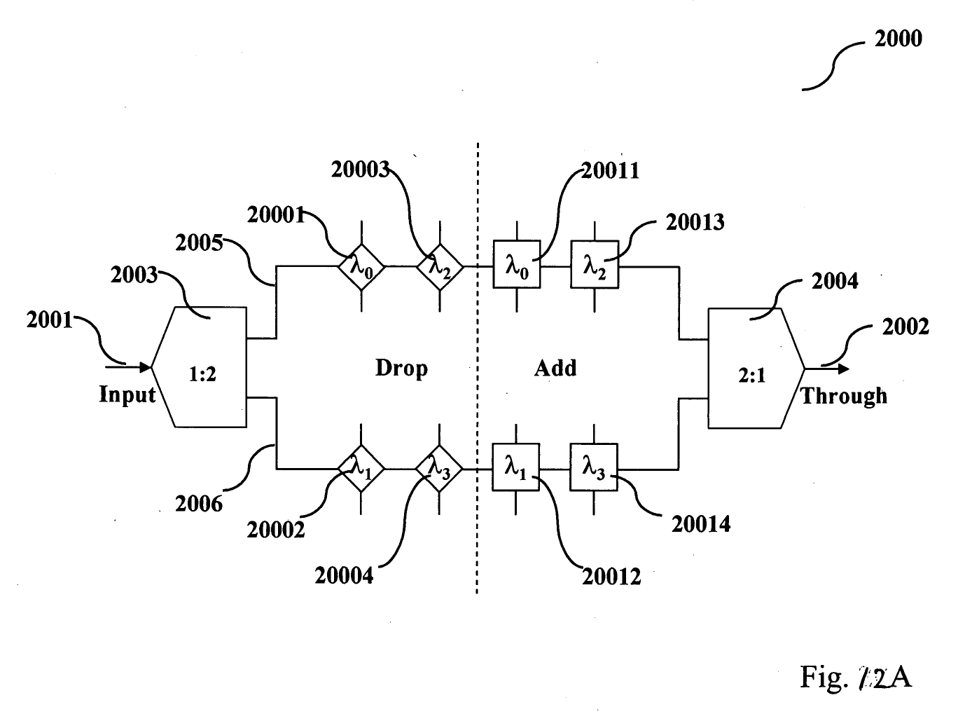

FIGS. 12A-12C show a 4-channel OADM that is based on the 1:2 optical wavelength interleavers shown in FIGS. 2 and 4 and the wavelength selective optical “drop” and “add” switches shown in FIGS. 11A˜11B. Elements with thin outline indicate that they are in the “off” state; those with thick (or bold) outline indicate that they are in the “on” state.

Let the wavelengths at input 2001 be λ₁, λ₂, λ₃ and λ₄ in this illustrative example. Based on properties of 1:2 optical wavelength interleavers as explained via FIGS. 2 and 4 and 3A˜3C, the input wavelengths are split into two sets such that the odd-numbered channel wavelengths (λ₁ and λ₃) propagate along the upper path 2005 and the even-numbered ones (λ₂ and λ₄) along the lower path 2006. As the optical “drop” and the “add” switches along path 2005 are transparent to odd-numbered channel wavelengths, and likewise along path 2006, these two sets of channel wavelengths are recombined via the 2:1 optical wavelength interleaver 2004. It should be noticed that when all the wavelength selective optical switches are in the “off” state (as in FIG. 12A), the OADM is transparent to all channel wavelengths.

As explained in FIGS. 10A˜10B, one of the advantages of this construction is the substantial crosstalk reduction between channels. Although the structure may be more complex than the prior art, the reduction in crosstalk in many applications justifies this tradeoff.

Again, as an illustrative example, it is shown in FIG. 12B that when the λ₃ “drop” switch 2011 along the upper path is turned on, signals of the λ₃ channel from input are directed to port 2012.

Referring to FIG. 12C, after signals of the λ₃ channel from the input are directed to port 2022 (with the λ₃ optical “drop” switch 2021 “on”), new signals (of the λ₃ channel) can be added through port 2024 with the λ₃ optical “add” switch 2023 “on”.

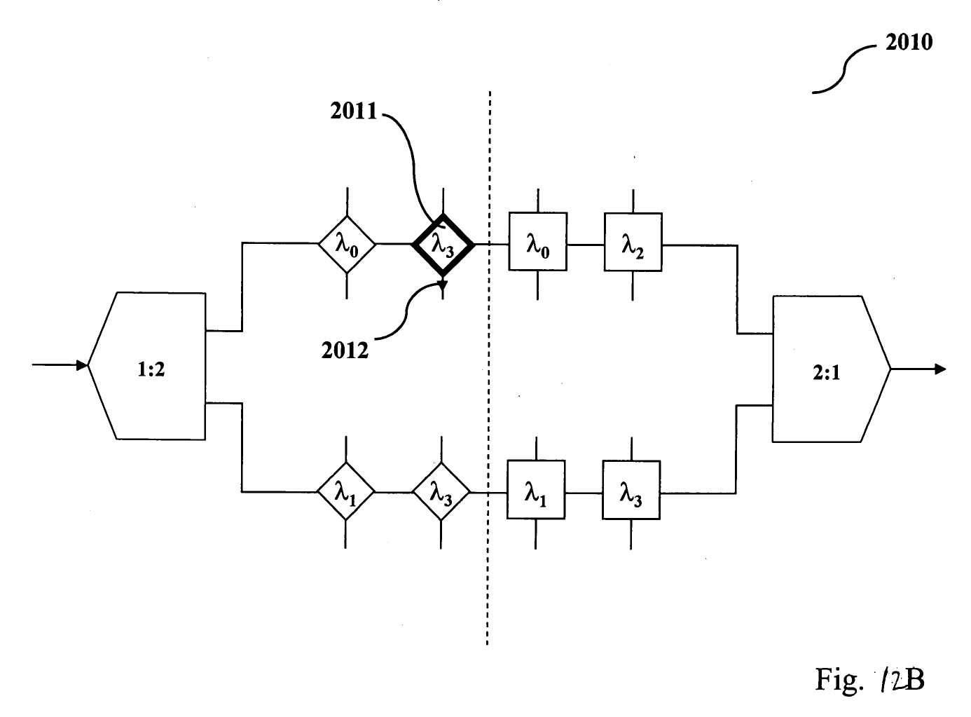

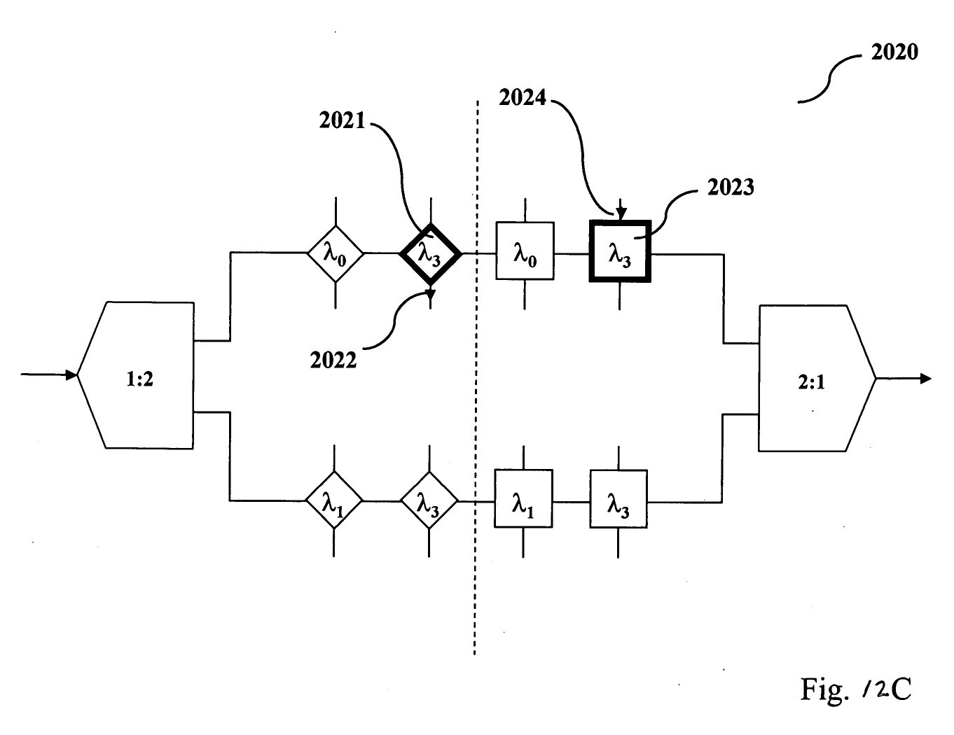

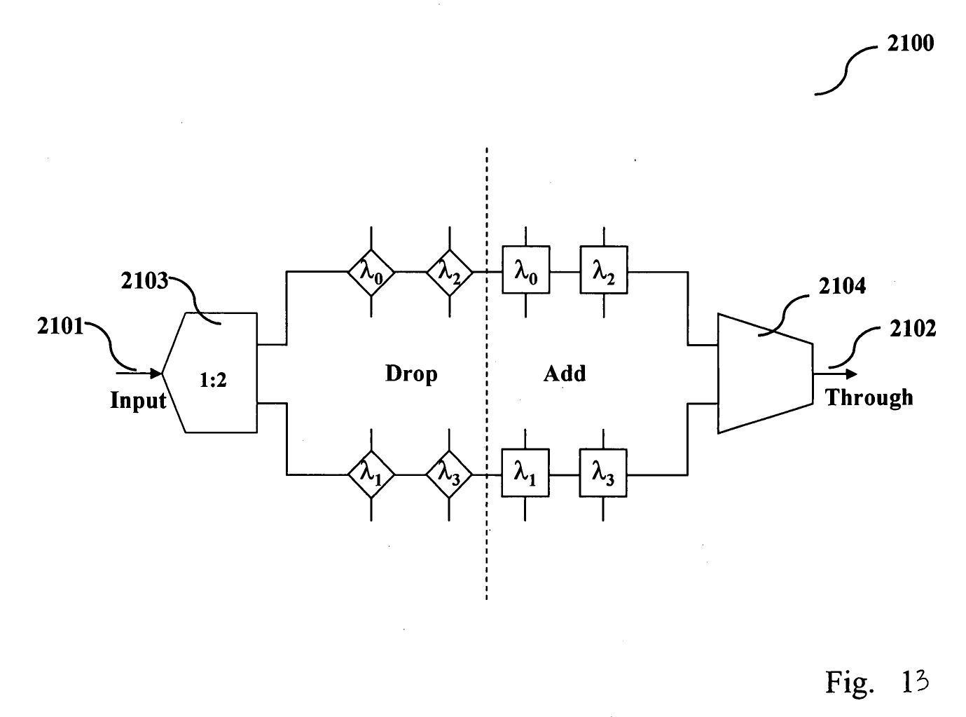

FIG. 13 shows a schematic where the output 2:1 optical wavelength interleaver of the schematic in FIG. 12A is replaced by a two-to-one optical waveguide combiner. As mentioned earlier, given the same input the two-to-one optical waveguide combiner (FIG. 7A) functions similar to a 2:1 optical wavelength interleaver (FIG. 4).

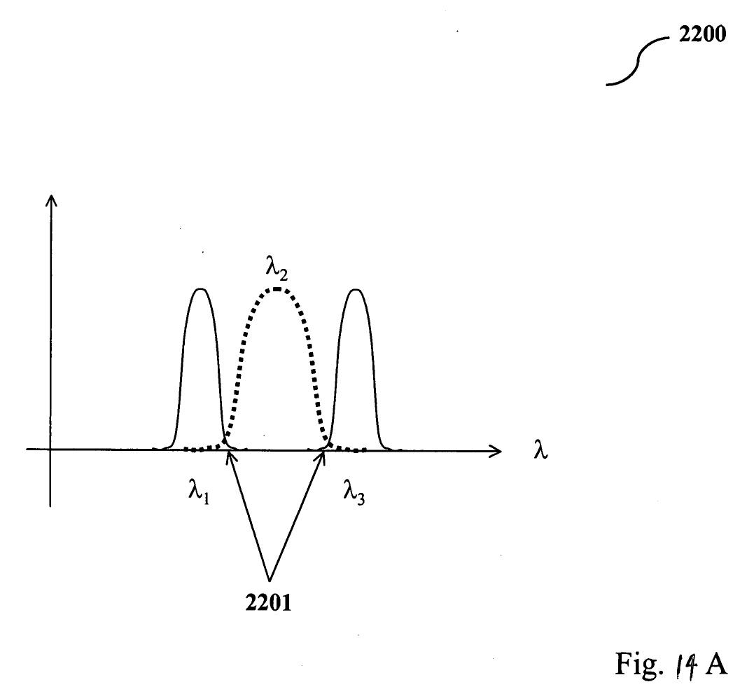

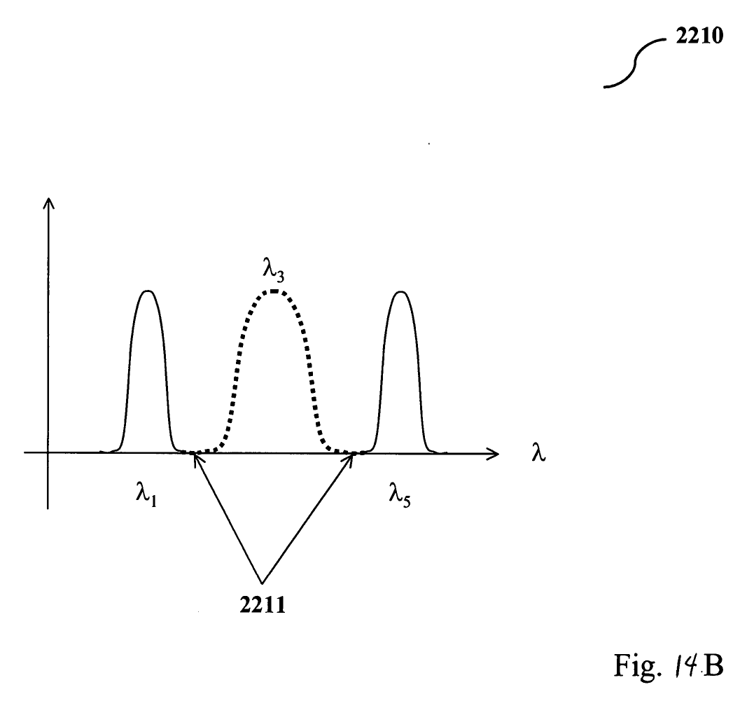

In FIG. 10B, it is assumed that the bandwidth of the wavelength selective optical switch (that is, width of the dotted curve) is comparable to that of the channels. In the case that the switch bandwidth is wider (see FIG. 14A), channel crosstalk may still occur.

If the wavelength channels propagating along the same path are spaced even further apart, and if the “off” state of the wavelength selective optical switch occupies a channel midway in between, channel crosstalk can again be avoided. In the case illustrated in FIG. 14B, as compared to the case in FIG. 10B the channel spacing is doubled. Even if the switch bandwidth (the dotted curve) is now wider, if the “off” state occupies far enough from either channels the channel crosstalk 2211 is small.

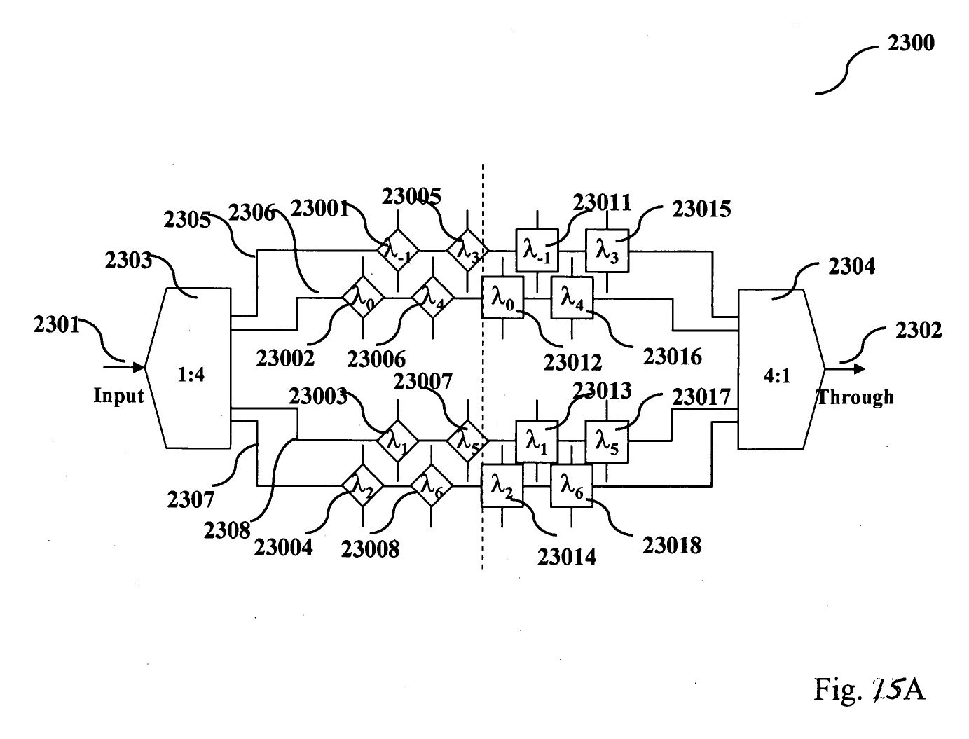

To realize further channel separation along the same path, the schematics in FIG. 1 5A is suggested. Let the wavelengths at input 2301 be λ₁, λ₂, λ₃, λ₄, λ₅, λ₆, λ₇ and λ₈ in this illustrative example. FIGS. 15A˜15C are for explaining functions and operations of an 8-channel OADM, which is based on the 1:4 optical wavelength interleavers shown in FIGS. 5A˜5B and the wavelength selective optical “drop” and “add” switches shown in FIGS. 11A˜11B. Elements with thin outline indicate that they are in the “off” state; those with thick outline indicate that they are in the “on” state. Again, the advantage of this architecture is the substantial crosstalk reduction as illustrated in FIG. 14B.

As explained earlier with FIGS. 5A˜5B and 6A˜6E, with a 1:4 optical wavelength interleaver the input WDM signals are divided up such that the λ₁ and λ₅ channels are directed to path 2305, the λ₂ and λ₄ channels are directed to path 2306, the λ₃ and λ₇ channels are directed to path 2308, and the λ₄ and λ₈ channels are directed to path 2307. Thus, four branches are formed instead of two branches of FIG. 12A.

Notice that along each of the four paths, spacing between adjacent channels is quadrupled. While the wavelength selective optical switches are in the “off” state (as in FIG. 15A), each of them can occupy any wavelength which is not used. Channel crosstalk and/or power loss between channels are thereby further reduced.

Referring to FIG. 15B, in this example when the wavelength selective optical “drop” switch 2311 is turned “on”, input signals in the λ₅ channel are dropped at port 2312.

Referring to FIG. 15C, moreover, while the wavelength selective optical “drop” switch 2321 is “on”, if the wavelength selective optical “add” switch 2323 is also turned “on”, new signals for the λ₅ channel can be added via port 2324.

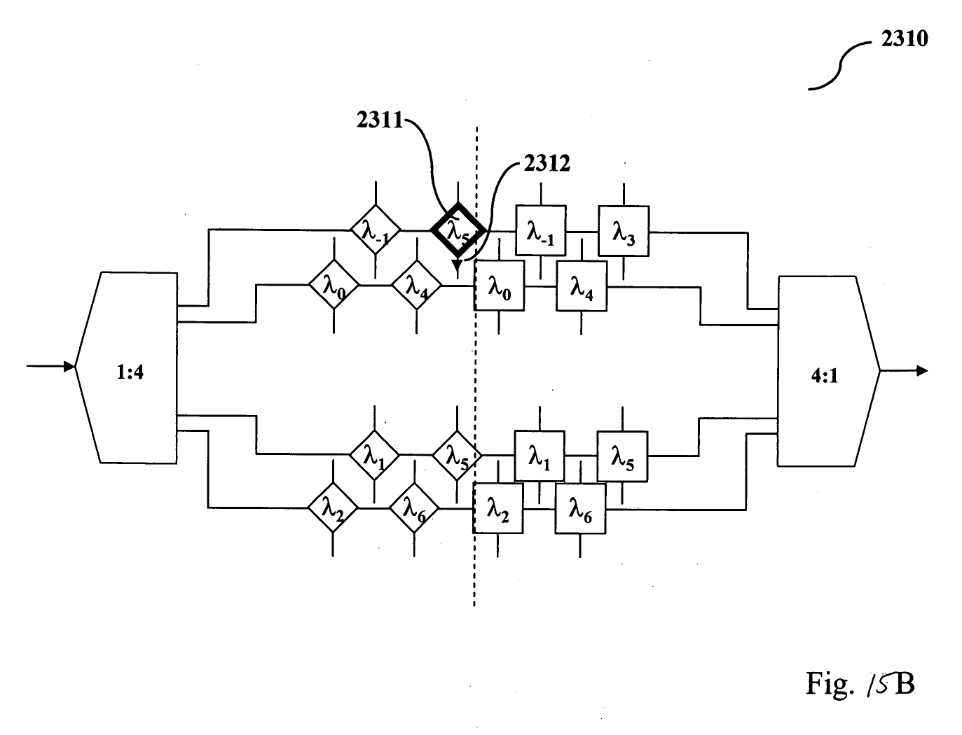

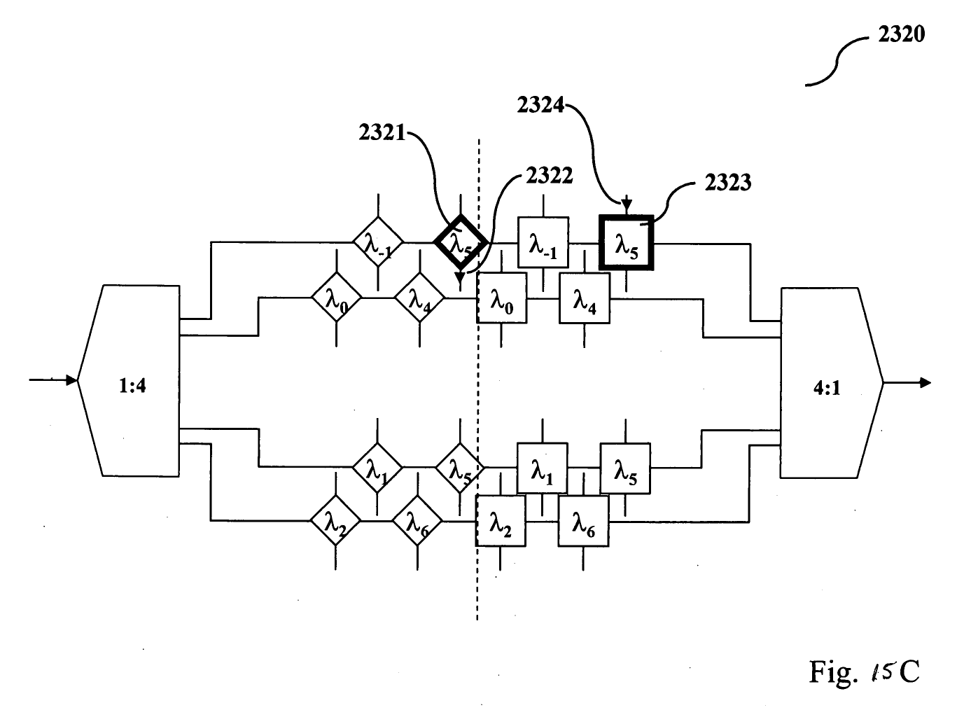

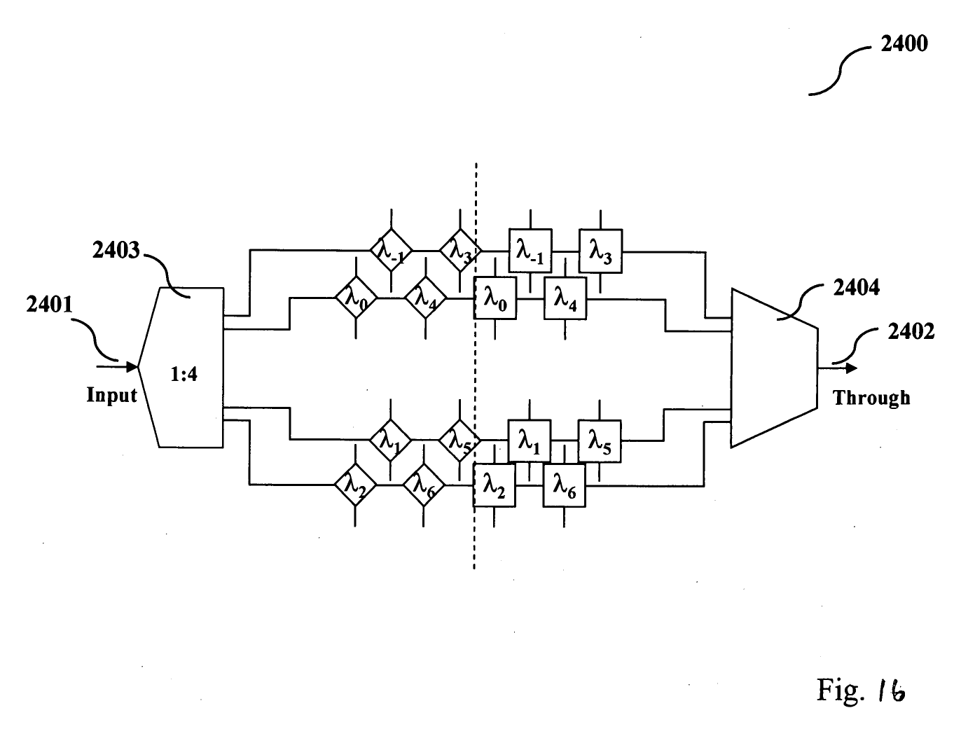

FIG. 16 shows a schematic where the output 4:1 optical wavelength interleaver of the schematic in FIG. 15A is replaced by a four-to-one optical waveguide combiner. As mentioned earlier, given the same input, the four-to-one optical waveguide combiner (FIG. 7B) functions similar to a 4:1 optical wavelength interleaver (FIG. 5B).

To generalize, the first embodiment of this invention relates to the design of an N-channel OADM utilizing:

(1) two 1:M optical wavelength interleavers,

(2) M optical paths,

(3) P (where P times M is greater than or equal to N) wavelength selective “add” optical switches, and

(4) the same number of wavelength selective “drop” optical switches on each path.

FIGS. 12A˜12C and 13 illustrate the case when N=4 and M=2, and FIGS. 15A˜15C and 16 illustrate the case when N=8 and M=4. These are merely illustrative examples and the contemplated combinations are nearly endless for an N-channel OADM based on this method. In each design, signal degradation due to propagation loss and optical switches are reduced by a factor of M compared to the conventional design. This embodiment is advantageous, therefore, in cases where this factor-of-M reduction outweighs signal degradation due to the two interleavers.

The architecture above can be adapted to use combination add/drop switches. Thus, a wavelength selective (λ₃) optical “add/drop” switch is shown in FIG. 17. The bold outline of the elements indicates that they are in the “on” state. When the wavelength selective (λ₃) optical “add/drop” switch in FIG. 17 is “on”, input signals in the λ₃ channel coming from port 2503 are directed to “drop” port 2505. Meanwhile, new signals with wavelength λ₃*(λₖ=λₖ*) coming from the port 2501 are directed to output port 2504. The switch is transparent to all other input wavelengths otherwise.

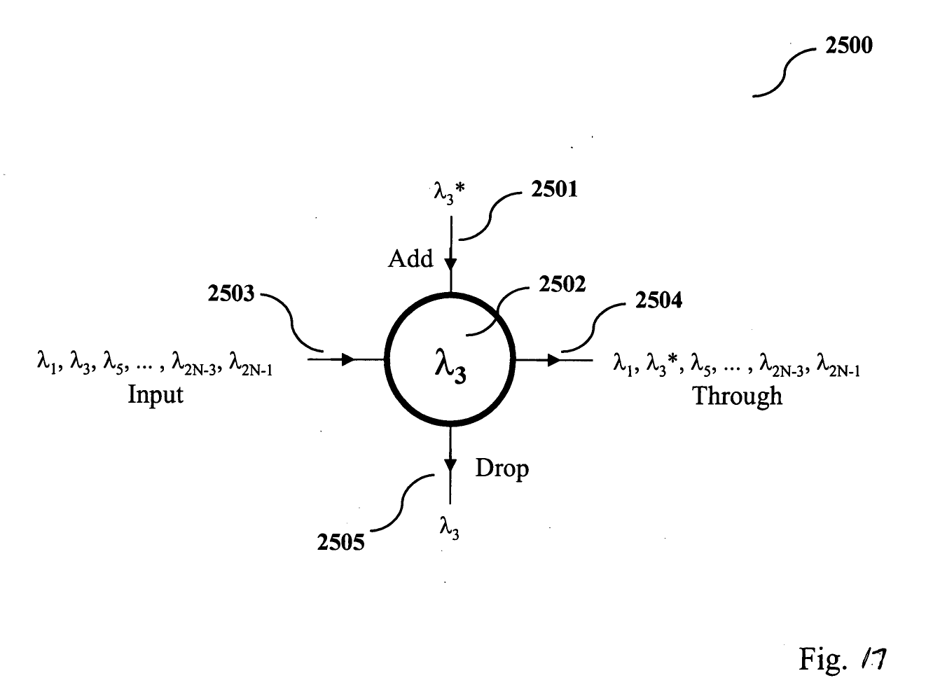

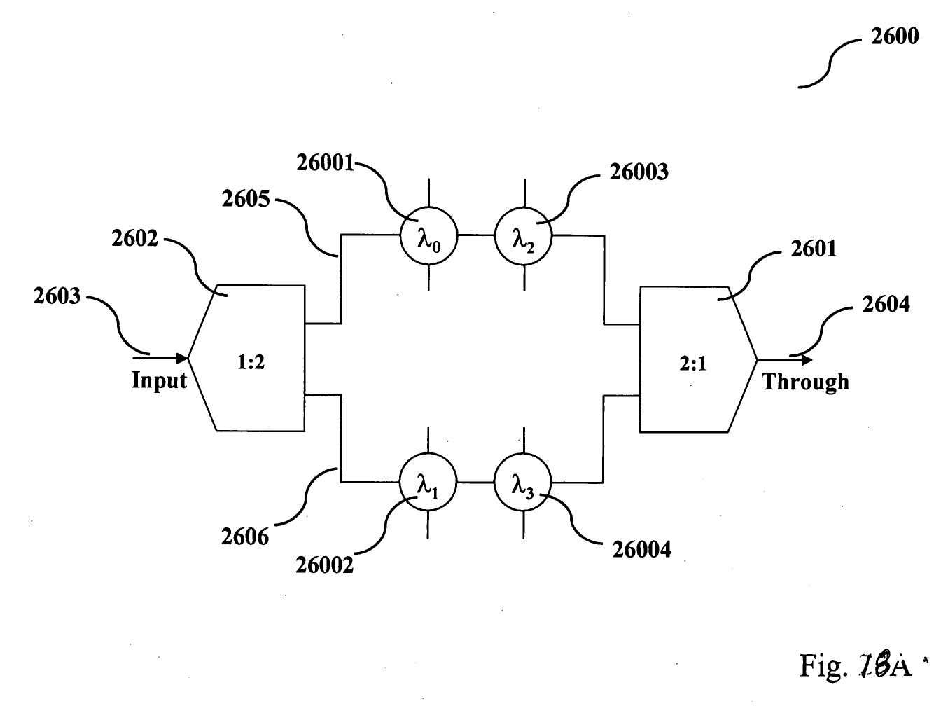

Functions and operations of a 4-channel OADM are explained through FIGS. 18A˜18B. The switch is based on the 1:2 optical wavelength interleavers shown in FIGS. 2 and 4 and the wavelength selective optical “add/drop” switch shown in FIG. 17.

Let the wavelengths at input 2603 be λ₁, λ₂, λ₃ and λ₄ in this illustrative example. As in the previous case, the input wavelengths are split into two sets such that the odd-numbered channel wavelengths (λ₁ and λ₃) propagate along the upper path 2605 and the even-numbered ones (λ₂ and λ₄) along the lower path 2606. Since the “add/drop” switches along path 2605 are transparent to odd-numbered channel wavelengths, and likewise along path 2606, these two sets of channel wavelengths are recombined via the 2:1 optical wavelength interleaver 2601. It should be noticed that when all the wavelength selective optical switches are in the “off” state (as in FIG. 18A) the OADM is transparent to all channel wavelengths.

Elements with thin outline indicate that they are in the “off” state; those with thick outline indicate that they are in the “on” state. Again, advantage of this construction is the substantial crosstalk reduction.

As described earlier with FIG. 17, when the wavelength selective optical “add/drop” switch 2611 is turned “on”, input signals in the λ₃ channel are dropped via port 2613 and new signals in the same channel can be added via port 2612.

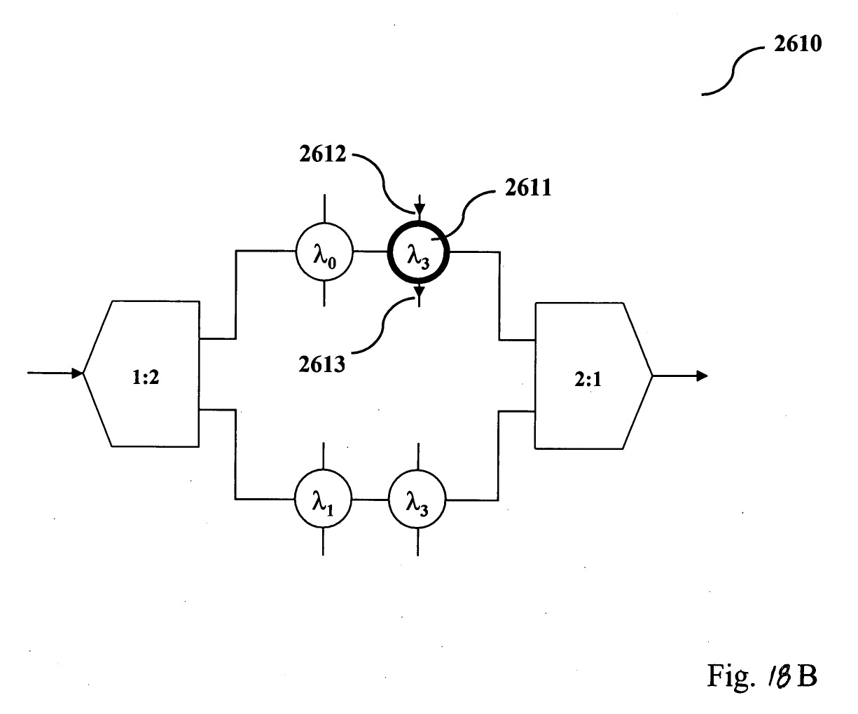

FIG. 19 shows a schematic where the output 2:1 optical wavelength interleaver of the schematic in FIG. 18A is replaced by a two-to-one optical waveguide combiner. As mentioned earlier, given the same input the two-to-one optical waveguide combiner (FIG. 7A) functions similar to a 2:1 optical wavelength interleaver (FIG. 4).

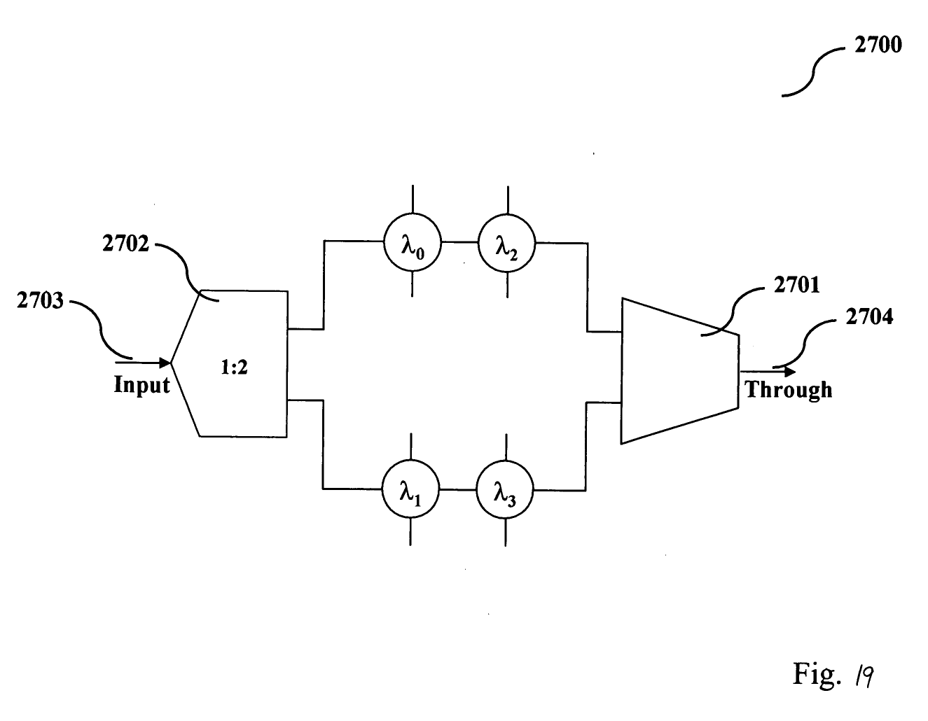

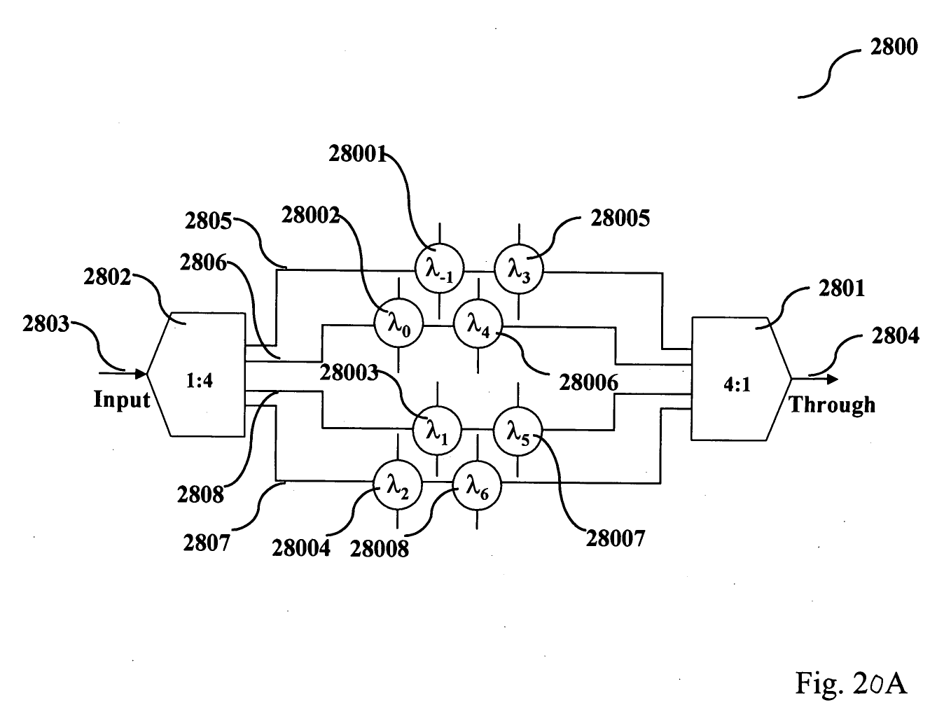

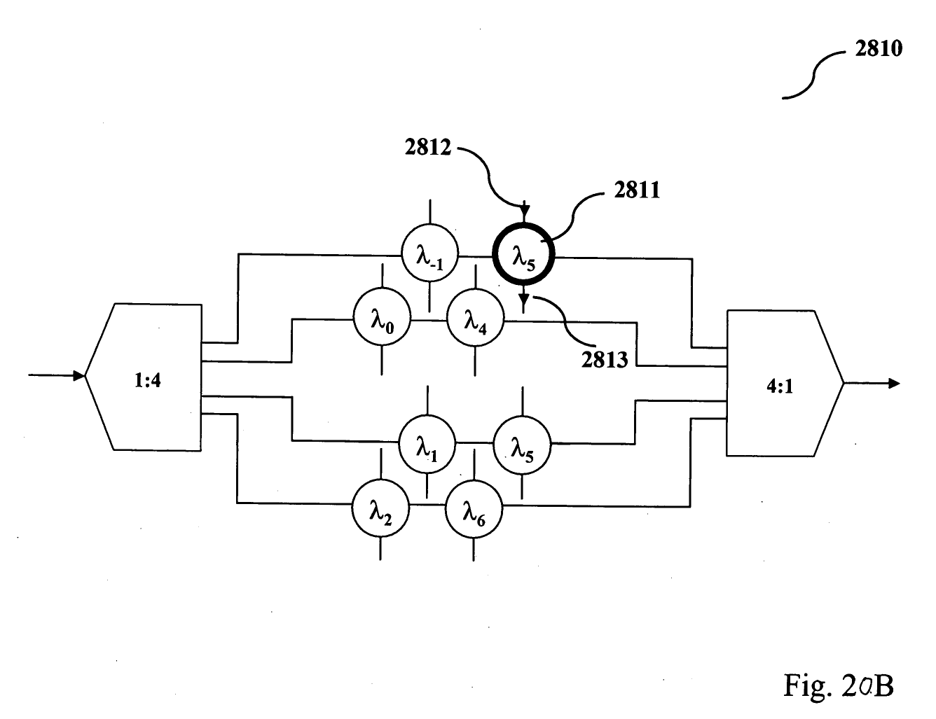

As in the previous case, FIGS. 20A˜20B show the functions and operations of an 8-channel OADM that is based on the 1:4 optical wavelength interleavers as shown in FIGS. 5A˜5B, and the wavelength selective optical “add/drop” switch as shown in FIG. 17. Elements with thin outline indicate that they are in the “off” state; those with thick outline indicate that they are in the “on” state. It should be noticed that when all the wavelength selective optical switches are in the “off” state (as in FIG. 20A) the OADM is transparent to all channel wavelengths.

Let the wavelengths at input 2803 be λ₁, λ₂, λ₃, λ₄, λ₅, λ₆, λ₇ and λ₈ in this illustrative example. As explained earlier with FIGS. 5A˜5B and 6A˜6E, with a 1:4 optical wavelength interleaver it is feasible to divide up the wavelength channels such that the λ₁ and λ₅ channels are directed to path 2805, the λ₂ and λ₆ channels are directed to path 2806, the λ₃ and λ₇ channels are directed to path 2808, and the λ₄ and λ₈ channels are directed to path 2807.

Referring to description associated with FIG. 17, when the wavelength selective optical “add/drop” switch 2811 is turned “on”, input signals in the 5 channel are dropped via port 2813 and new signals in the same channel can be added via port 2812. Again, advantage of this construction is the substantial crosstalk reduction between channels.

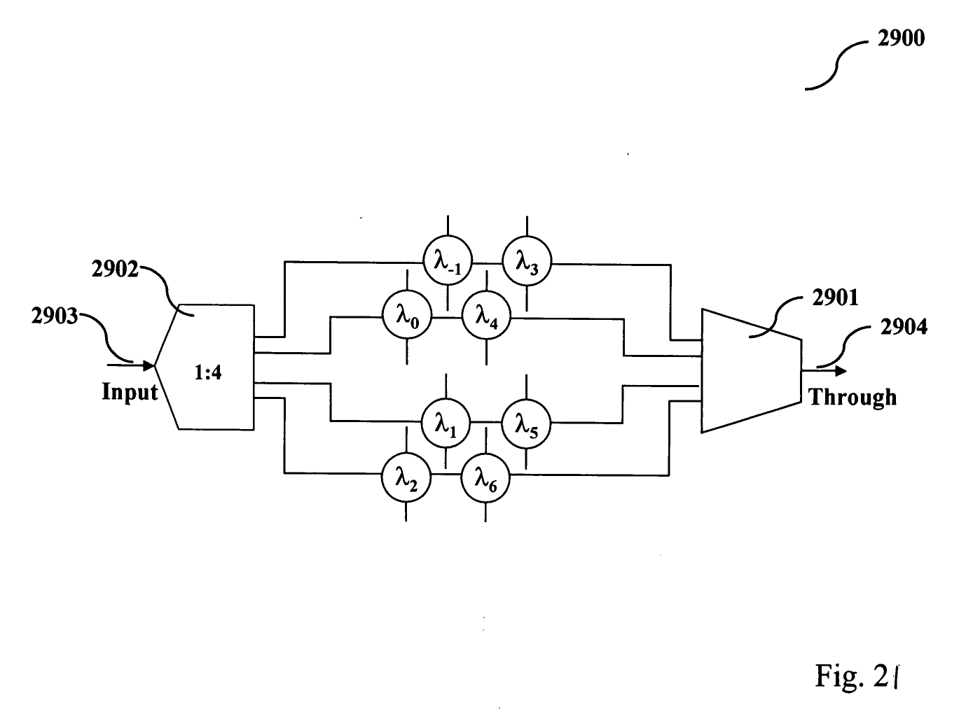

FIG. 21 shows a schematic where the output 4:1 optical wavelength interleaver of the schematic in FIG. 20A is replaced by a four-to-one optical waveguide combiner. As mentioned earlier, given the same input the four-to-one optical waveguide combiner (FIG. 7B) functions similar to a 4:1 optical wavelength interleaver (FIG. 5B).

To generalize, the second embodiment of this invention relates to the design of an N-channel OADM utilizing

(1) two 1:M optical wavelength interleavers,

(2) M optical paths,

(3) P (where P times M is greater than or equal to N) wavelength selective “add/drop” optical switches, on each path.

FIGS. 18A˜18C and 19 illustrate the case when N=4 and M=2, and FIGS. 20A˜20C and 21 illustrate the case when N=8 and M=4. These are merely illustrative examples and the contemplated combinations are nearly endless for an N-channel OADM based on this method. In each design, signal degradation due to propagation loss and optical switches are reduced by a factor of M compared to the conventional design. This embodiment is advantageous, therefore, in cases where this factor-of-M reduction outweighs signal degradation due to the two interleavers.

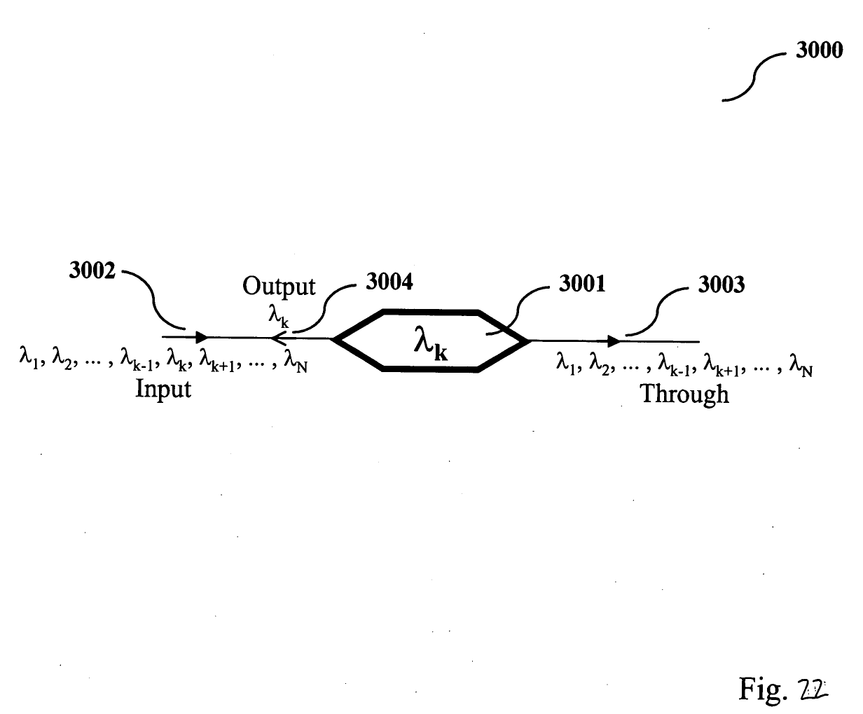

The architecture described above can be adapted to use wavelength selective reflective optical switch as shown in FIG. 22. The thin outline of the element indicates that it is in the “off” state; thick outline when it is in the “on” state.

As an example, shown in FIG. 22 is a wavelength selective (λₖ) reflective optical switch 3001 such that when it is turned “on”, the reflected output signal 3004 propagates in a direction opposite to the input signals 3002. The switch is transparent to all signals in other wavelengths.

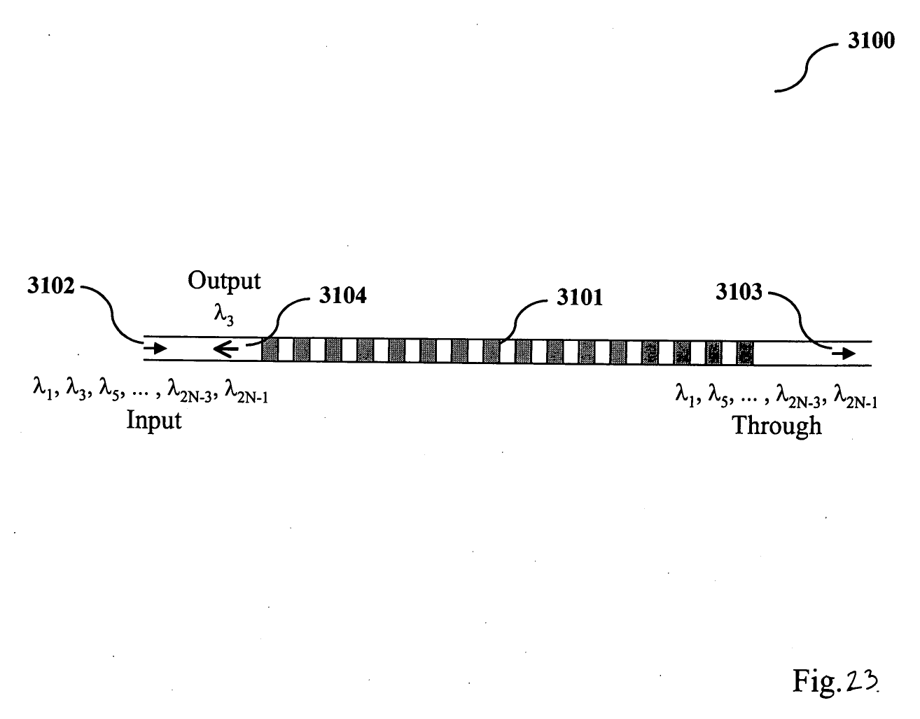

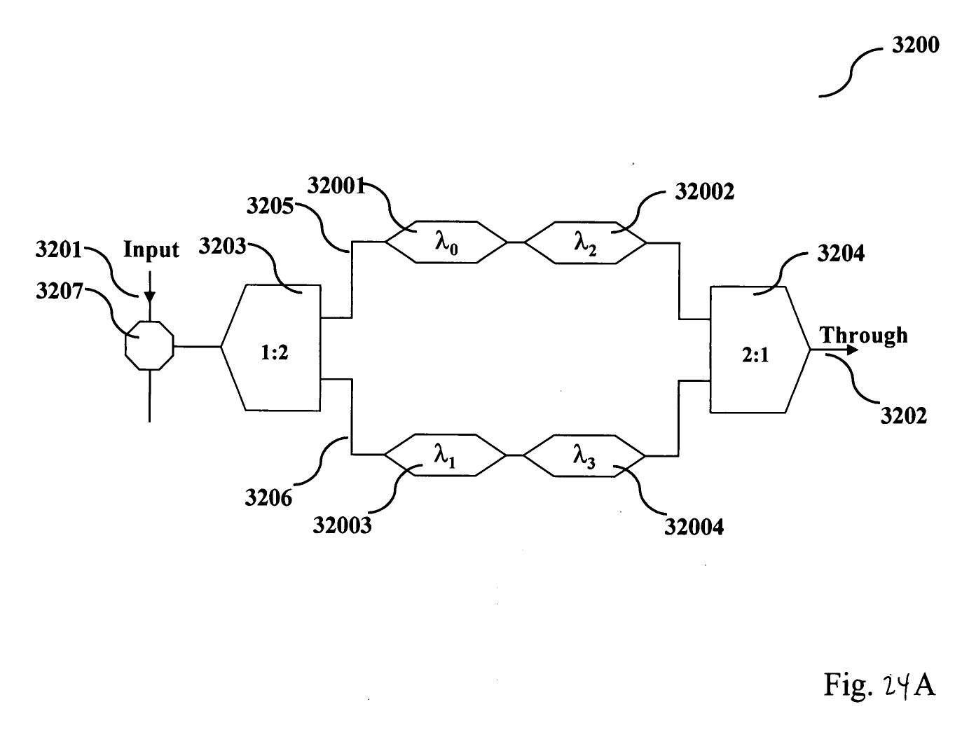

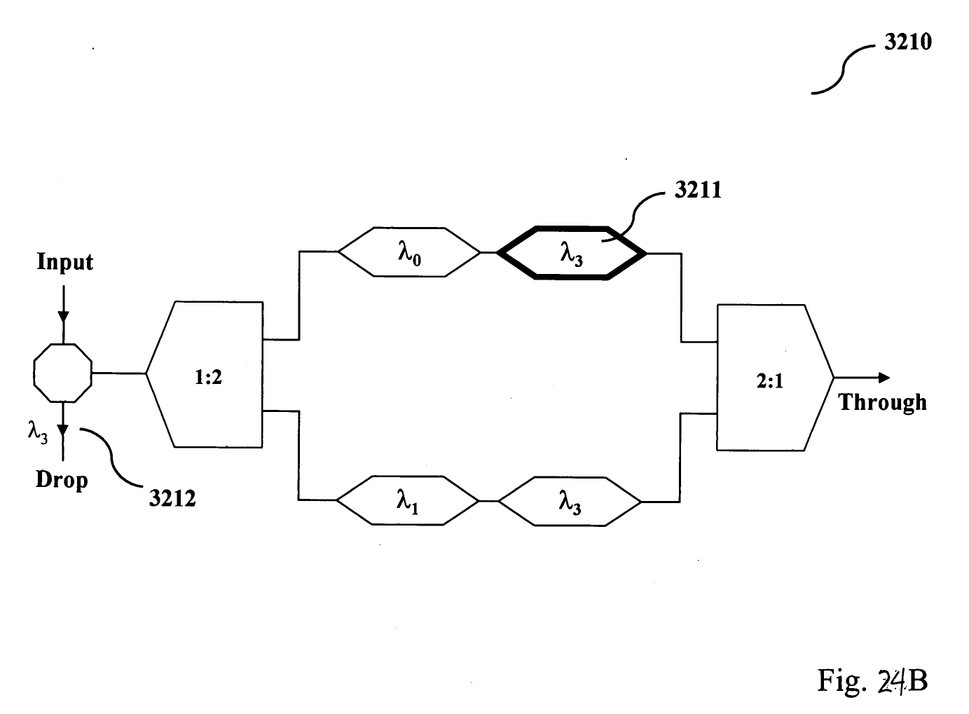

FIG. 23 shows the structure of a grating-based wavelength selective reflective optical switch. FIGS. 24A˜24B explain the functions and operations of a 4-channel optical “drop” multiplexer which is based on the 1:2 optical wavelength interleavers as shown in FIGS. 2 and 4, wavelength selective reflective optical switches as shown in FIG. 22, and the optical circulator as shown in FIG. 8. Elements with thin outline indicate that they are in the “off” state; those with thick outline indicate that they are in the “on” state.

Let the wavelengths at input 3201 be λ₁, λ₂, λ₃ and λ₄ in this illustrative example. In this case, the input signals go through the optical circulator 3207, enter the 1:2 optical wavelength interleaver 3203 and the channel wavelengths are split into two sets such that the odd-numbered channel wavelengths (λ₁ and λ₃) propagate along the upper path 3205 and the even-numbered ones (λ₂ and λ₄) along the lower path 3206. Since the wavelength selective reflective optical switches along path 3205 are transparent to odd-numbered channel wavelengths, and likewise along path 3206, these two sets of channel wavelengths are recombined via the 2:1 optical wavelength interleaver 3204. It should be noticed that when all the wavelength selective optical switches are in the “off” state (as in FIG. 24A) the optical “drop” multiplexer is transparent to all channel wavelengths.

As an illustrative example, it is shown in FIG. 24B that when the λ₃ wavelength selective reflective optical switch 3211 along the upper path is turned on, signals of the λ₃ channel from input are directed to drop port 3212.

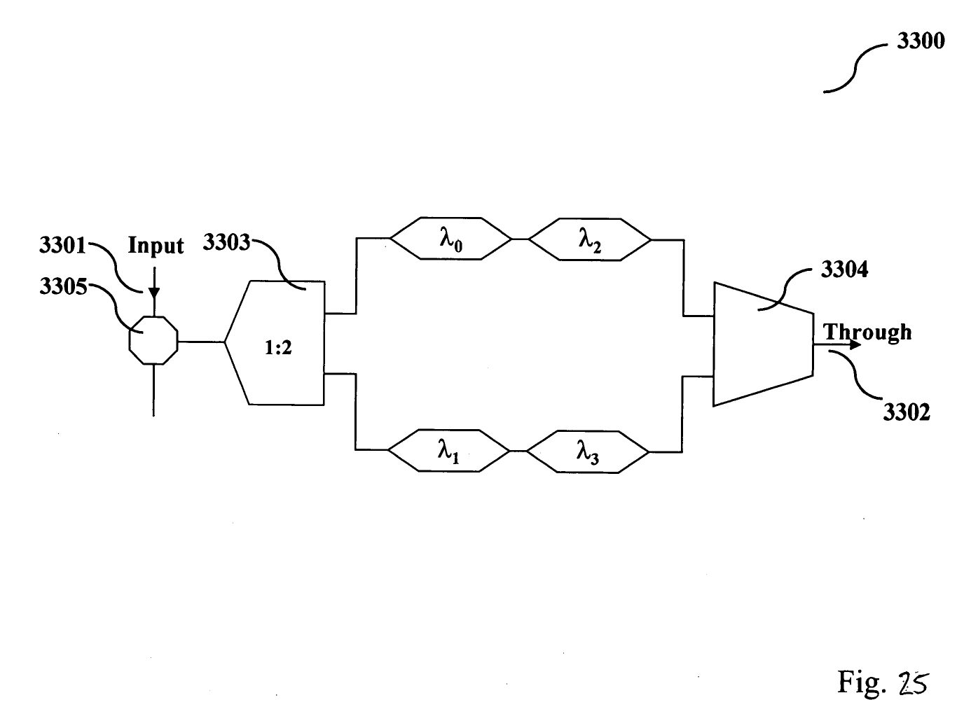

FIG. 25 shows a schematic where the output 2:1 optical wavelength interleaver of the schematic in FIG. 24A is replaced by a two-to-one optical waveguide combiner. As mentioned earlier, given the same input the two-to-one optical waveguide combiner (FIG. 7A) functions similar to a 2:1 optical wavelength interleaver (FIG. 4). Functions and operations of schematics as shown in FIGS. 24A and 25 are expected to be identical. An advantage of this construction is the substantial crosstalk reduction between channels.

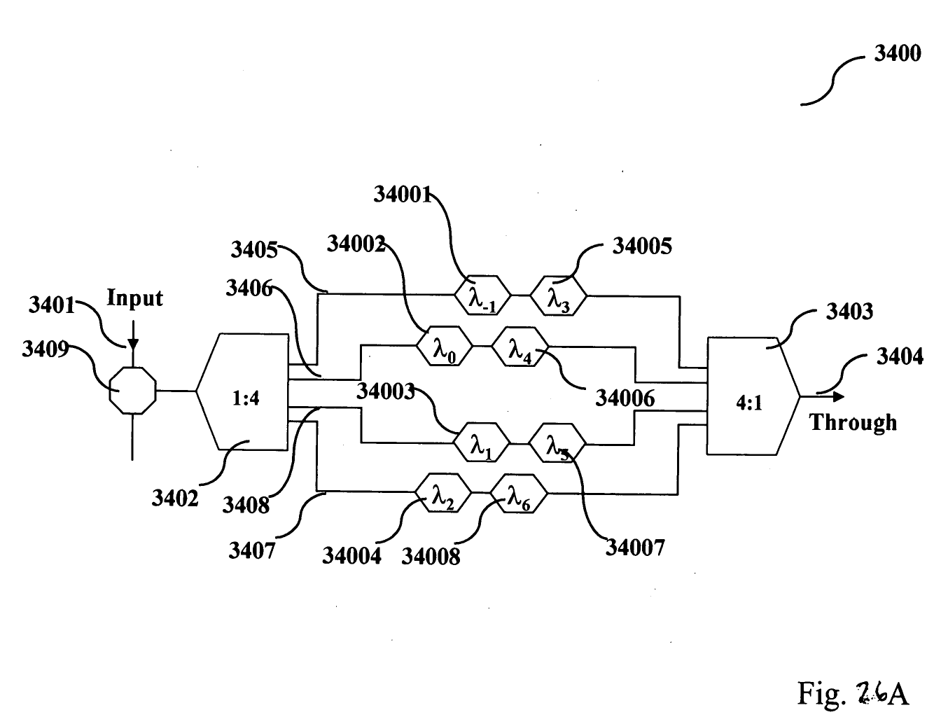

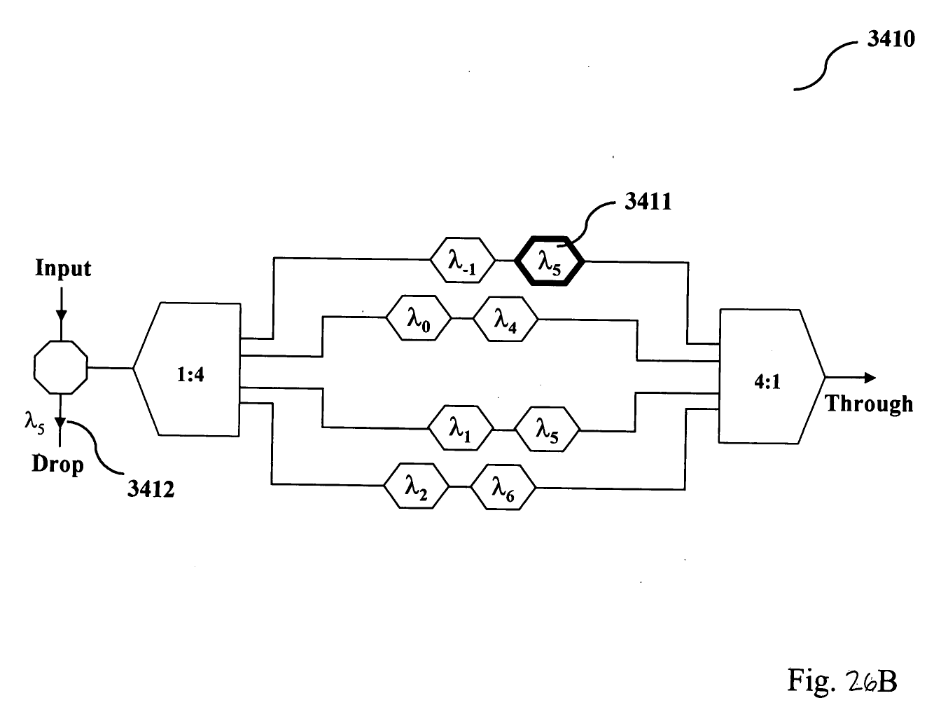

Through FIGS. 26A˜26B, to explain the functions and operations of an 8-channel optical “drop” multiplexer which is based on the 1:4 optical wavelength interleavers as shown in FIGS. 7A and 7B, the wavelength selective reflective optical switches as shown in FIG. 22, and the optical circulator as shown in FIG. 8. Elements with thin outline indicate that they are in the “off” state; those with thick outline indicate that they are in the “on” state.

Let the wavelengths at input 3401 be λ₁, λ₂, λ₃, λ₄, λ₅, λ₆, λ₇ and λ₈ in this illustrative example. As explained earlier with FIGS. 5A˜5B and 6A˜6E, with a 1:4 optical wavelength interleaver it is feasible to divide up the wavelength channels such that the λ₁ and λ₅ channels are directed to path 3405, the λ₂ and λ₆ channels are directed to path 3406, the λ₃ and λ₇ channels are directed to path 3408, and the λ₄ and λ₈ channels are directed to path 3407.

Considering FIG. 26B and referring to description associated with FIG. 22, when the wavelength selective optical reflective switch 3411 is turned “on”, input signals in the λ₅ channel are reflected and dropped via port 3412. An advantage of this construction is the substantial crosstalk reduction between channels.

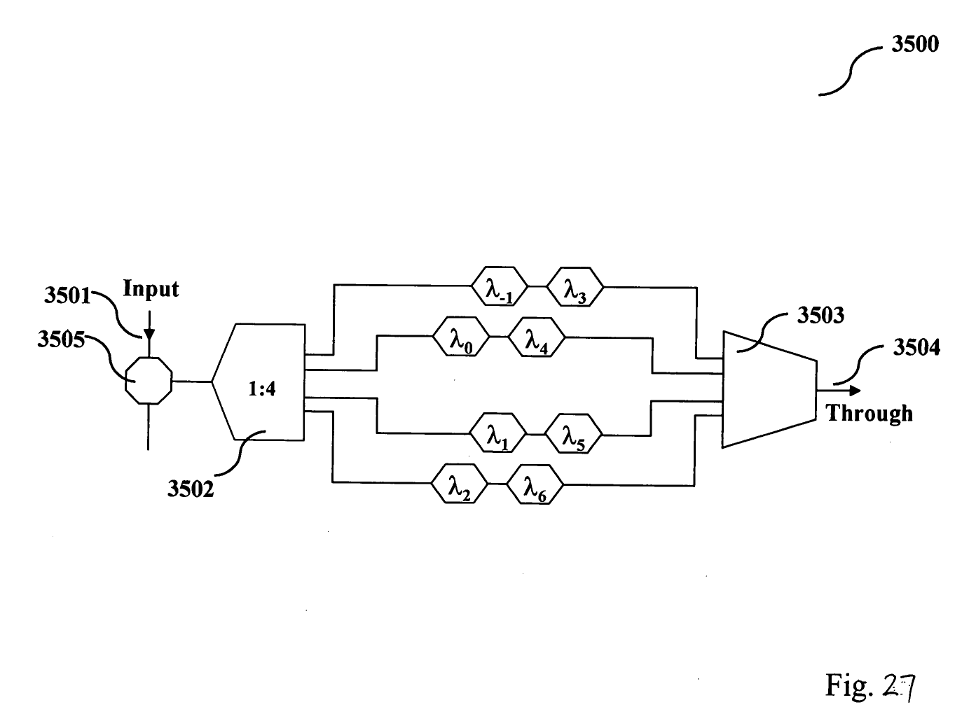

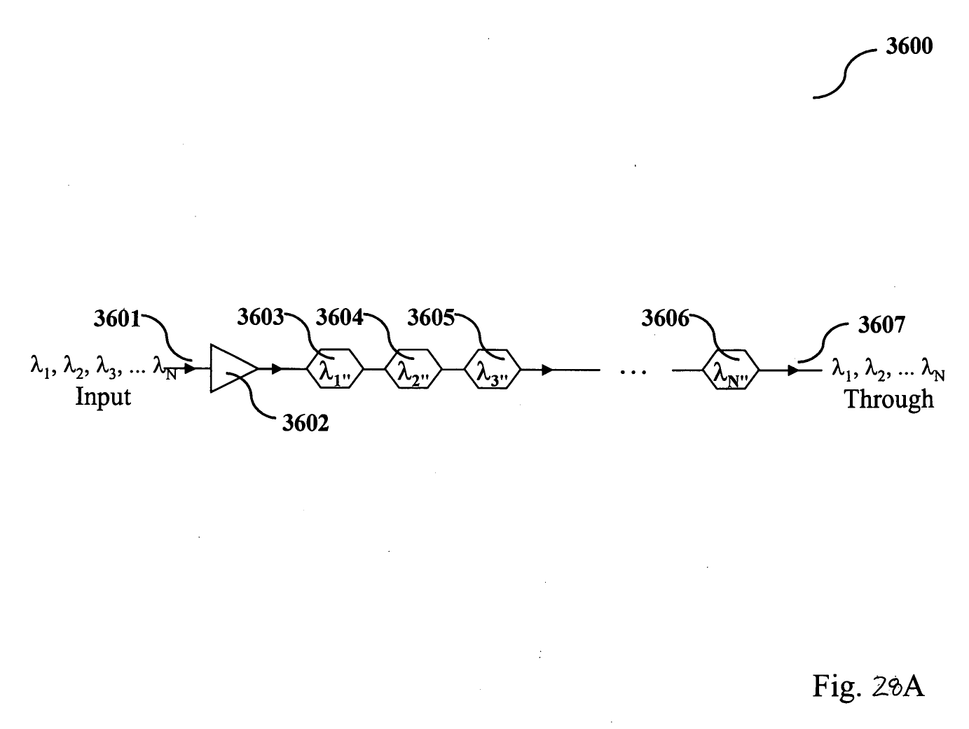

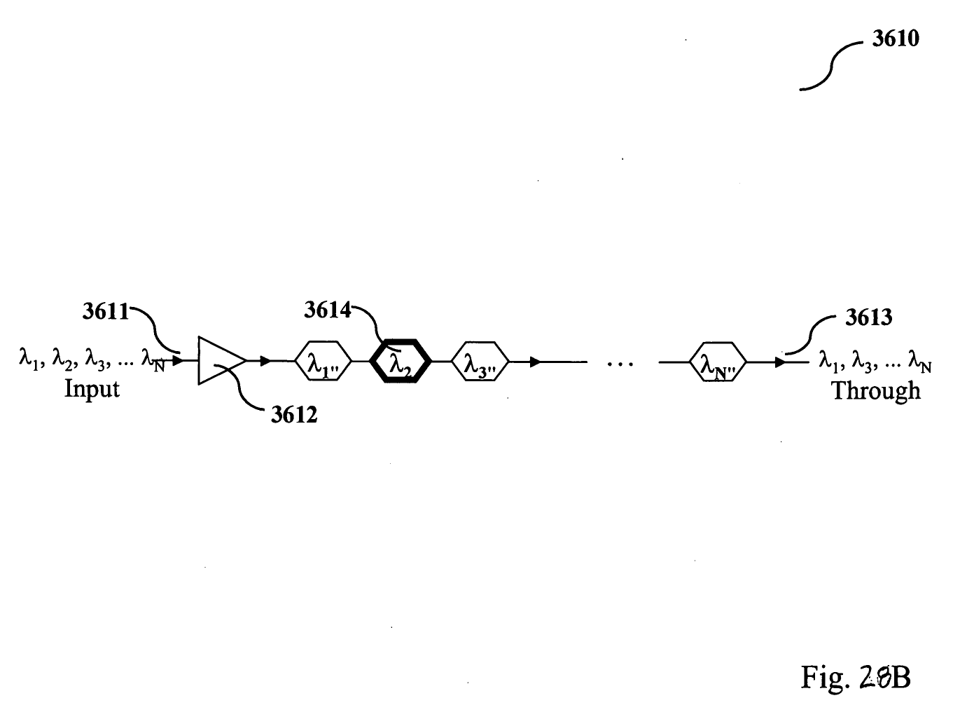

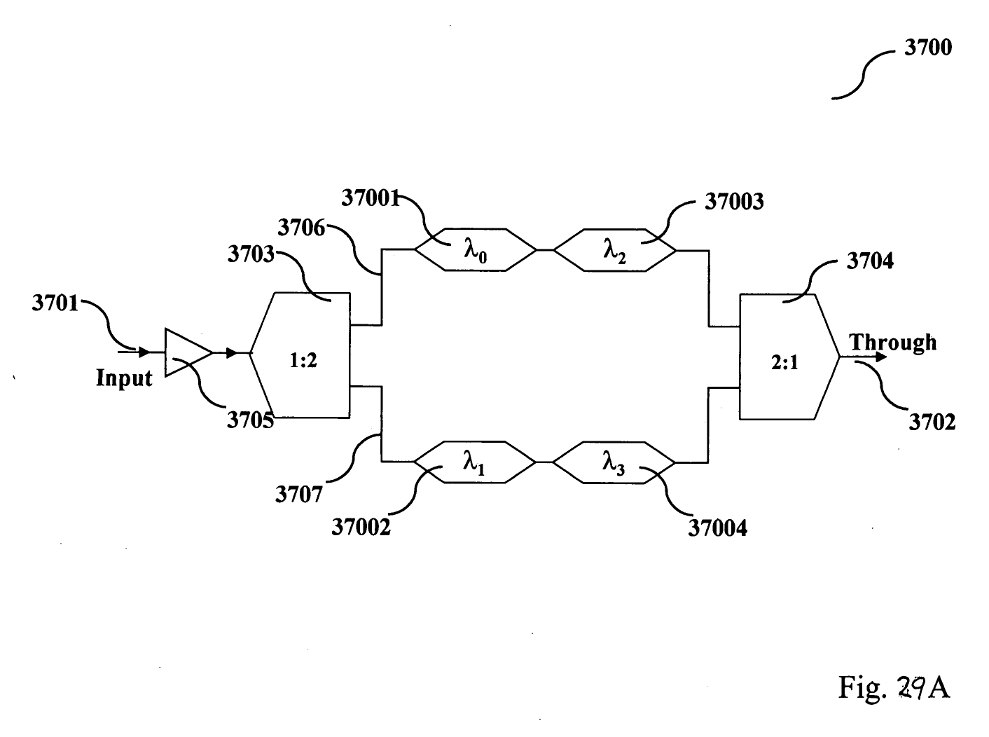

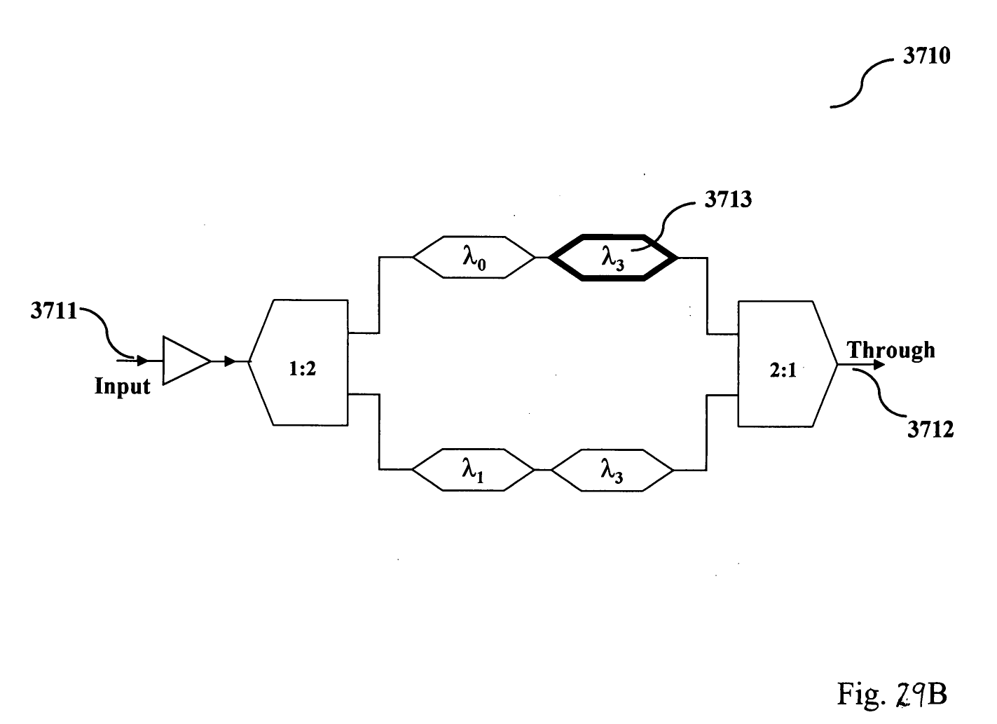

FIG. 27 shows a schematic where the output 4:1 optical wavelength interleaver of the schematic in FIG. 26A is replaced by a four-to-one optical waveguide combiner. As mentioned earlier, given the same input the four-to-one optical waveguide combiner (FIG. 7B) functions similar to a 4:1 optical wavelength interleaver (FIG. 5B).

To generalize, the third embodiment of this invention relates to the design of an N-channel optical “drop” multiplexer utilizing:

(1) two 1:M optical wavelength interleavers,

(2) M optical paths,

(3) one optical circulator, and

(4) P (where P times M is greater than or equal to N) wavelength selective reflective optical devices on each path.

FIGS. 24A˜24C and 25 illustrate the case when N=4 and M=2, and FIGS. 26A˜26C and 27 illustrate the case when N=8 and M=4. These are merely illustrative examples and the contemplated combinations are nearly endless for an N-channel OADM based on this method. In each design, signal degradation due to propagation loss and optical multiplexers are reduced by a factor of M compared to the conventional design. This embodiment is advantageous, therefore, in cases where this factor-of-M reduction outweighs signal degradation due to the two interleavers.

FIG. 28A shows a schematic of an optical wavelength blocker. It consists of wavelength selective optical reflective switches as shown in FIG. 22A˜22B and an optical isolator as shown in FIG. 9.

When the optical wavelength blocker is “off” (as in FIG. 28A) all the wavelength selective optical reflective switches are tuned to wavelengths other than the input signal wavelengths, that is, none of the wavelengths λ_{1″}, λ_{2″}, . . . , λ_{N″} is the same as any of the wavelengths λ₁, λ₂, . . . , λ_{N}.

Consider the illustrative example as in FIG. 28B where the λ₂ optical reflective switch is “on”, input signals in the λ₂ channel are reflected but blocked by the optical isolator 3612. All the λ₂ channel signals are blocked from reaching the output port 3613 as a result.

FIGS. 29A˜29B explain the functions and operations of a multi-wavelength optical blocker which is based on the 1:2 optical wavelength interleavers as shown in FIGS. 2 and 4, wavelength selective reflective optical switches as shown in FIGS. 22A˜22B, and the optical isolator as shown in FIG. 9. Elements with thin outline indicate that they are in the “off” state; those with thick outline indicate that they are in the “on” state.

Let the wavelengths at input 3701 be λ₁, λ₂, λ₃ and λ₄ in this illustrative example. In this case, the input signals go through the optical isolator 3705, enter the 1:2 optical wavelength interleaver 3703 and the channel wavelengths are split into two sets such that the odd-numbered channel wavelengths (λ₁ and λ₃) propagate along the upper path 3706 and the even-numbered ones (λ₂ and λ₄) along the lower path 3707. Since the wavelength selective reflective optical switches along path 3706 are transparent to odd-numbered channel wavelengths, and likewise along path 3707, these two sets of channel wavelengths are recombined via the 2:1 optical wavelength interleaver 3704. It should be noticed that when all the wavelength selective optical switches are in the “off” state (as in FIG. 29A) the multi-wavelength optical blocker is transparent to all channel wavelengths.

As an illustrative example, it is shown in FIG. 29B that when the λ₃ wavelength selective reflective optical switch 3713 along the upper path is turned on, signals of the λ₃ channel from input 3711 are blocked from passing through to output port 3712.

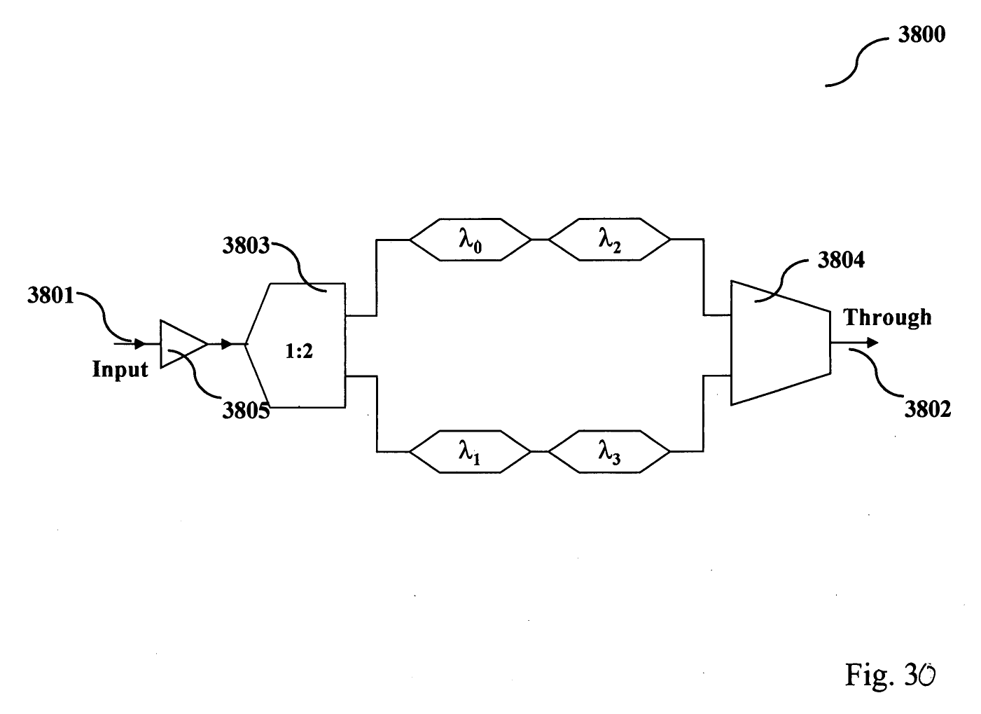

FIG. 30 shows a schematic where the output 2:1 optical wavelength interleaver of the schematic in FIG. 29A is replaced by a two-to-one optical waveguide combiner. As mentioned earlier, given the same input the two-to-one optical waveguide combiner (FIG. 7A) functions similar to a 2:1 optical wavelength interleaver (FIG. 4).

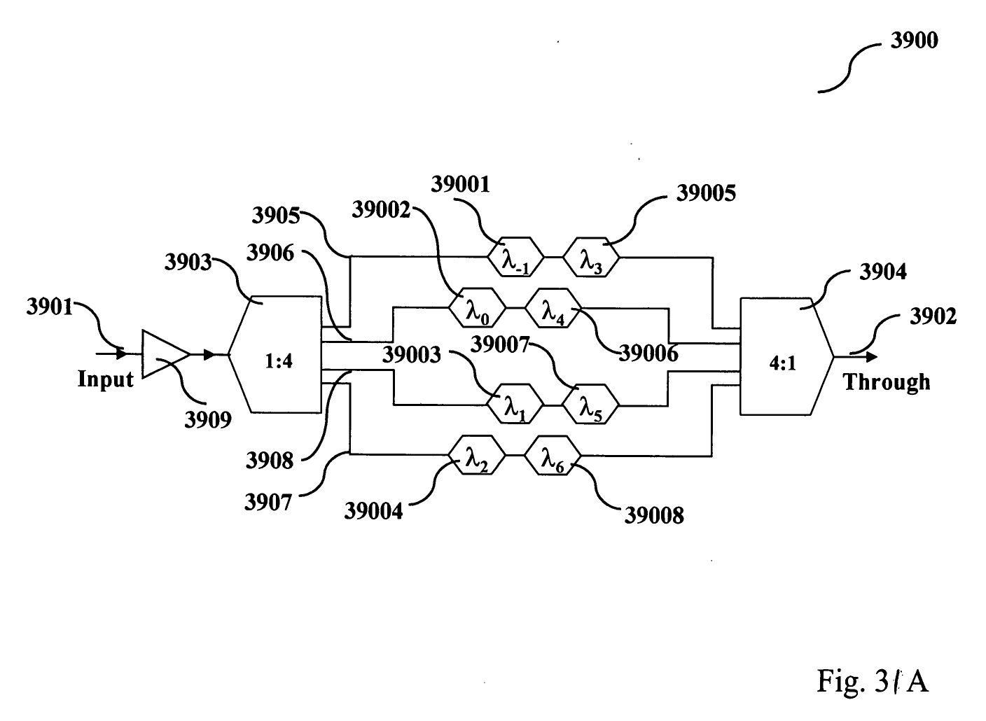

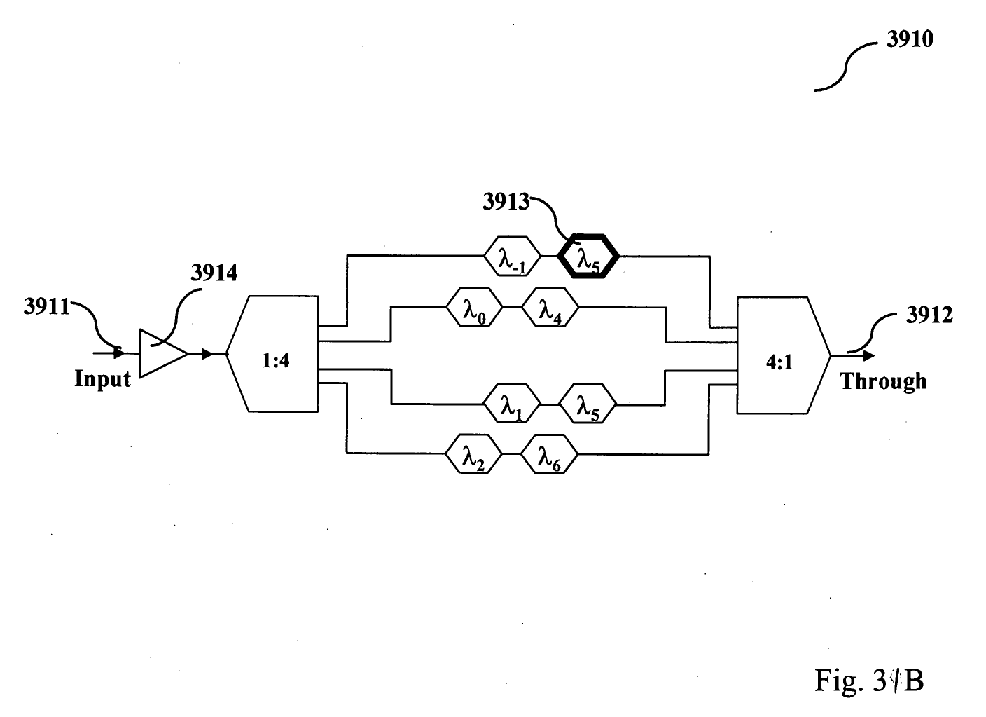

Through FIGS. 31A˜31B, the functions and operations of a multi-wavelength optical blocker are explained. It is based on the 1:4 optical wavelength interleavers as shown in FIGS. 7A and 7B, wavelength selective reflective optical switches as shown in FIG. 22, and the optical isolator as shown in FIG. 9. Elements with thin outline indicate that they are in the “off” state; those with thick outline indicate that they are in the “on” state.

Let the wavelengths at input 3901 be λ₁, λ₂, λ₃, λ₄, λ₅, λ₆, λ₇ and λ₈ in this illustrative example. As explained earlier with FIGS. 5A˜5B and 6A˜6E, with a 1:4 optical wavelength interleaver it is feasible to divide up the wavelength channels such that the λ₁ and λ₅ channels are directed to path 3905, the λ₂ and λ₆ channels are directed to path 3906, the λ₃ and λ₇ channels are directed to path 3908, and the λ₄ and λ₈ channels are directed to path 3907.

Considering FIG. 31B and referring to description associated with FIG. 22, when the wavelength selective optical reflective switch 3913 is turned “on”, input signals in the λ₅ channel are reflected and blocked at the optical isolator 3914.

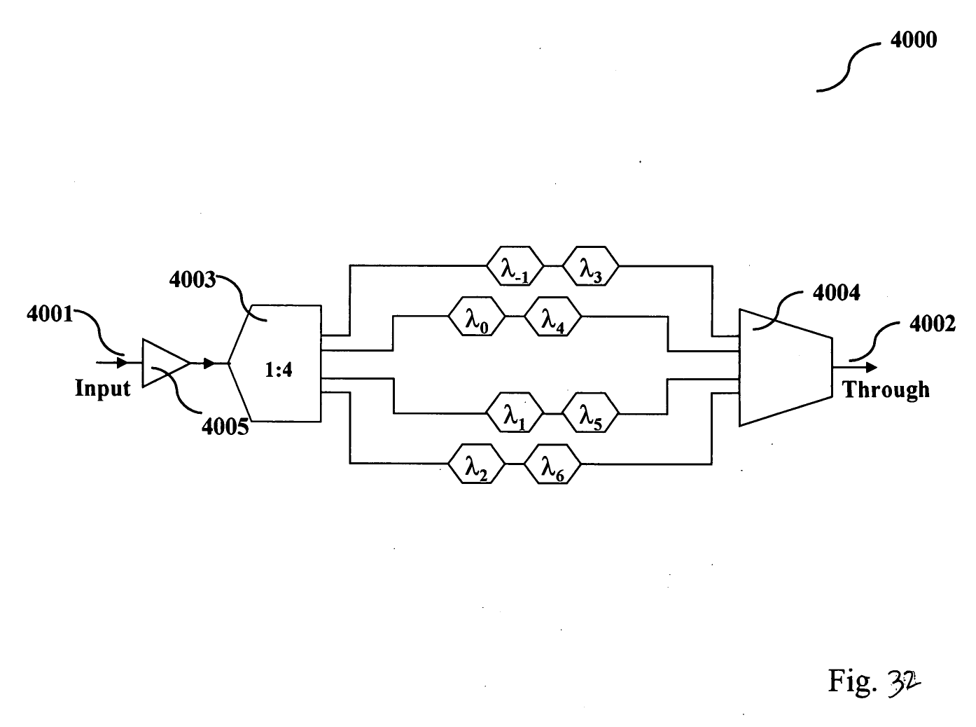

FIG. 32 shows a schematic where the output 4:1 optical wavelength interleaver of the schematic in FIG. 31A is replaced by a four-to-one optical waveguide combiner. As mentioned earlier, given the same input the four-to-one optical waveguide combiner (FIG. 7B) functions similar to a 4:1 optical wavelength interleaver (FIG. 5B).

To generalize, the fourth embodiment of this invention relates to the design of an N-channel optical wavelength blocker utilizing

(1) two 1:M optical wavelength interleavers,

(2) M optical paths,

(3) one optical isolator, and

(4) P (where P times M is greater than or equal to N) wavelength selective reflective optical devices on each path.

FIGS. 29A˜29C and 30 illustrate the case when N=4 and M=2, and FIGS. 32A˜32C and 32 illustrate the case when N=8 and M=4. These are merely illustrative examples and the contemplated combinations are nearly endless for an N-channel OADM based on this method. In each of the design, signal degradation due to propagation loss and optical devices are reduced by a factor of M compared to the conventional design. This embodiment is advantageous, therefore, in cases where this factor-of-M reduction outweighs signal degradation due to the two interleavers.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

1. An optical add/drop multiplexer (OADM) that receives as input a wavelength division multiplexed (WDM) optical signal having a plurality of channels (λ₁, λ₂, . . . , λ_{N}), the multiplexer comprising:
a 1:M optical interleaver for separating said WDM optical signal into M sets of optical signals, each of said M sets of optical signals including a subset of said plurality of channels;
M optical paths, each of said M optical paths propagating a corresponding one of said M sets of optical signals, each of said M optical paths including at least one wavelength selective add optical switch and at least one wavelength selective drop optical switch; and
a M:1 optical wavelength interleaver for combining said M sets of optical signals carried on said M optical paths into an output WDM optical signal.

2. The apparatus of claim 1 wherein each of said M optical paths include a wavelength selective add optical switch and a wavelength selective drop optical switch for each channel in said M sets of optical signals.

3. The apparatus of claim 1 wherein said 1:M optical interleaver is operative to separate every M^{th} channel from said input WDM optical signal such that each of said M sets of optical signals carries channels separated by M channels.

4. The apparatus of claim 1 wherein said M:1 optical interleaver is replaced with a M:1 optical combiner.

5. An optical add/drop multiplexer (OADM) that receives as input a wavelength division multiplexed (WDM) optical signal having a plurality of channels (λ₁, λ₂, . . . , λ_{N}), the multiplexer comprising:
a 1:M optical interleaver for separating said WDM optical signal into M sets of optical signals, each of said M optical sets of signals including a subset of said plurality of channels;
M optical paths, each of said M optical paths propagating a corresponding one of said M sets of optical signals, each of said M optical paths including at least one wavelength selective combination add/drop optical switch; and
a M:1 optical wavelength interleaver for combining said M sets of optical signals carried on said M optical paths into an output WDM optical signal.

6. The apparatus of claim 5 wherein each of said M optical paths include a wavelength selective combination add/drop optical switch for each channel in said M sets of optical signals.

7. The apparatus of claim 5 wherein said 1:M optical interleaver is operative to separate every M^{th} channel from said input WDM optical signal such that each of said M sets of optical signals carries channels separated by M channels.

8. The apparatus of claim 5 wherein said M:1 optical interleaver is replaced with a M:1 optical combiner.

9. An optical add/drop multiplexer (OADM) comprising:
an optical circulator for aggregating said plurality of channels into a wavelength division multiplexed (WDM) optical signal;
a 1:M optical interleaver for separating said WDM optical signal into M sets of optical signals, each of said M optical sets of signals including a subset of said plurality of channels;
M optical paths, each of said M optical paths propagating a corresponding one of said M sets of optical signals, each of said M optical paths including at least one wavelength selective reflective optical switch; and
a M:1 optical wavelength interleaver for combining said M sets of optical signals carried on said M optical paths into an output WDM optical signal.

10. The apparatus of claim 9 wherein each of said M optical paths include a wavelength selective reflective optical switch for each channel in said M sets of optical signals.

11. The apparatus of claim 9 wherein said 1:M optical interleaver is operative to separate every M^{th} channel from said input WDM optical signal such that each of said M sets of optical signals carries channels separated by M channels.

12. The apparatus of claim 9 wherein said M:1 optical interleaver is replaced with a M:1 optical combiner.

13. An optical add/drop multiplexer (OADM) comprising:
an optical isolator that has propagating therethrough a wavelength division multiplexed (WDM) optical signal;
a 1:M optical interleaver for separating said WDM optical signal into M sets of optical signals, each of said M sets of optical signals including a subset of said plurality of channels;
M optical paths, each of said M optical paths propagating a corresponding one of said M sets of optical signals, each of said M optical paths including at least one wavelength selective reflective optical switch; and
a M:1 optical wavelength interleaver for combining said M sets of optical signals carried on said M optical paths into an output WDM optical signal.

14. The apparatus of claim 13 wherein each of said M optical paths include a wavelength selective reflective optical switch for each channel in said M sets of optical signals.

15. The apparatus of claim 13 wherein said 1:M optical interleaver is operative to separate every M^{th} channel from said input WDM optical signal such that each of said M sets of optical signals carries channels separated by M channels.

16. The apparatus of claim 13 wherein said M:1 optical interleaver is replaced with a M:1 optical combiner.

17. A method of selectively adding, dropping, and multiplexing an wavelength division multiplexed (WDM) optical signal comprising:
separating said WDM optical signal into M sets of optical signals, each of said M sets of optical signals including a subset of said plurality of channels;
propagating said M sets of optical signals on M optical paths, each of said M sets of optical paths propagating a corresponding one of said M sets of optical signals, each of said M optical paths including at least one optical elements for adding or dropping a channel; and
combining said M sets of optical signals carried on said M optical paths into an output WDM optical signal.
